(19) United States
(12) Patent Application Publication
(10) Pub. No.: US 2012/0176457 A1
(43) Pub. Date: Jul. 12, 2012

(54) METHOD OF USING A DONOR ELEMENT HAVING A FLEXIBLE SUPPORT

(75) Inventors: JONATHAN V. CASPAR, Wilmington, DE (US); JEFFREY SCOTT METH, Landenberg, PA (US)

(73) Assignee: E. I. DU PONT DE NEMOURS AND COMPANY, Wilmington, DE (US)

(21) Appl. No.: 13/005,202

(22) Filed: Jan. 12, 2011

(51) Int. Cl. B41J 25/304

(52) U.S. Cl. 347/197

(57) ABSTRACT

A method for thermal mass transfer comprises providing a donor element with a support having a thickness (h) and a modulus (E), an adjacent transfer layer and a receiver element, wherein the receiver element is contacted with the transfer layer to form an assemblage. An imaging head having three or more beams of light is moved relative to the assemblage to cause imagewise mass transfer of the transfer layer onto the receiver element in a local pattern of three or more areas, each area having a local width (b) and local separation (2a) distinct from any adjacent local area, wherein when the modulus is greater than 1.5 and less than or equal to 5 gPa and the local width (b) is less than or equal to 250 microns and the local separation (2a) is less than or equal to 300 microns, the support layer thickness (h) is less than or equal to 45 microns; and wherein when the modulus is greater than 0.05 and less than or equal to 1.5 gPa and the local width (b) is less than or equal to 250 microns and the local separation (2a) is less than or equal to 500 microns, the support layer thickness (h) is less than or equal to 60 microns.

### BACKGROUND OF THE INVENTION

U.S. Pat. No. 5,164,742 to Baek et al. discloses a thermal printer that is adapted to form an image on a thermal print medium of a type in which a donor element transfers dye to a receiver element upon receipt of a sufficient amount of thermal energy. The printer includes a plurality of diode lasers that can be individually modulated to supply energy to selected dots on the medium in accordance with an information signal. The print head of the printer includes a fiber optic array having a plurality of optical fibers coupled to the diode lasers. The thermal print medium is supported on a rotatable drum, and the fiber optic array is movable relative to the drum. In order to prevent banding in an image produced on the print medium, the two outside fibers in the array are used for preheating and postheating of inner scan lines. A thermal print medium for use with the printer can be, for example, a medium disclosed in U.S. Pat. No. 4,772,582 ('582), entitled “Spacer Bead Layer for Dye-Donor Element Used in Laser Induced Thermal Dye Transfer,” granted Sep. 20, 1988. Any material can be used as the support for the dye-donor element of the '582 patent provided it is dimensionally stable and can withstand the heat generated by the laser beam. Such materials include polyesters such as poly(ethylene terephthalate); polyamides; polycarbonates; glassine paper; condenser paper; cellulose esters such as cellulose acetate; fluorine polymers such as polyvinylidene fluoride or poly(tetrafluoroethylene-co-hexafluoropropylene); polyethers such as polyoxymethylene; polyacetals; polyolefins such as polystyrene, polyethylene, polypropylene or methylpentane polymers. The support generally has a thickness of from about 2 to about 250 microns. It may also be coated with a subbing layer, if desired.

Methods of transferring layers from thermal transfer elements, as well as articles formed by such methods, are disclosed by U.S. Pat. No. 6,228,543 of Mizuno, et al. (the '543 patent). In Table 4 of the '543 patent, a thermal transfer element of a 0.1 mm polyethylene terephthalate (PET) substrate, a light to heat conversion layer, an interlayer, and a transfer coating having a plasticizer was imaged by a moving laser spot to give transferred lines that were characterized by line width and edge roughness in comparison to a example without plasticizer. The results show that the addition of the co-reactive plasticizer increased the transferred line width and resulted in less edge roughness. A suitable thickness for the support for the layers of the thermal transfer element ranges from, for example, 0.025 to 0.15 mm, preferably 0.05 to 0.1 mm, although thicker or thinner supports for the layers of the thermal transfer element may be used.

U.S. 20050158652A1 discloses a thermal transfer process wherein an imaging material is transferred from an imaging donor to a receiver to form a pattern of the imaging material on the receiver. The donor has a support layer that is not thermally transferred to the receiver element, but that serves to hold material in an appropriate alignment and distance to the receiver element during thermal transfer in an assemblage. Films are commonly used as supports, varying from 10 to 150 microns in thickness. In one embodiment, the support layer comprises a 25 micron thick transparent polyester film comprising polyethylene terephthalate and a blue colorant having a thin layer of chromium transmitting from 40 to 60% of photons corresponding to 832 nanometer wavelength radiation on the side which supports the imaging material.

U.S. Pat. No. 6,242,140 Kwon, et al. to Samsung SDI Co, Ltd., discloses a method for manufacturing a color filter by thermal transfer using a laser beam, including steps of placing a transfer film having thermal color layers on a substrate; and irradiating a laser beam with uniform energy distribution onto the transfer film to transfer the color layers onto the substrate in a pattern. The transfer film includes a base film, preferably with a thickness of 10 to 500 microns. The base film is formed of an excellent polymer film, for example, polyester, polyacrylate, epoxy resin, polyethylene, polypropylene or polystyrene. In particular, polyethylene terephthalate (PET) film, one of polyester films, is more preferred. The laser beam can be dithered. When a plurality of dithering laser beams are synchronized to scan a color filter pattern, a plurality of color filter patterns can be manufactured at the same time. In the case where the width of the pattern is 60-150 microns, which is actually equal to the width of a color filter used for a color LCD, preferably the laser beam is formed in an elliptical shape having a major axis of 200-500 microns and a minor axis of 20-50 microns.

U.S. Pat. No. 6,682,862 Chang, et al. to L.G. Philips LCD Co., Ltd., discloses a method of fabricating a color filter substrate for a liquid crystal display device including the steps of forming a black matrix on a substrate; adhering a color transcription film to the substrate; disposing a laser head over the color transcription film; repeatedly scanning the color transcription film; and removing the color transcription film so that a color filter pattern remains in color filter pattern regions. The color filter pattern takes into account pixels with a width generally within a range of about 70 microns to about 100 microns; a length generally within a range of about 200 microns to about 350 microns, and a separation between pixels of about 5 microns to about 40 microns.

U.S. Pat. No. 6,146,792 by Blanchet-Fincher et al. to E. I. du Pont de Nemours and Company discloses improved processes for laser thermal imaging and imaged laserable assemblages obtained using the improved processes. One application of the improved process provides a color filter element. Disclosed is a donor element useful for thermal imaging in accordance with the processes, that comprises at least three separate and distinct layers, which are an ejection layer, a heating layer, and a transfer layer. In certain embodiments, a donor support can also be present. One disclosed example is a four layer donor element of the following layers in the sequence listed: a 2 mil PET support layer (DuPont MYLAR®. 200D), a one micron polyvinyl chloride ejection layer, a heating layer of 80 angstroms of nickel sputtered onto the ejection layer, and a transfer layer coating that is pigmented. Also disclosed was a three layer donor element of the following layers in the sequence listed: a four mil polyvinyl chloride (PVC) flexible ejection layer, 90 angstroms of nickel sputtered onto the ejection layer, and a transfer layer that is pigmented. (One mil equals 25.4 microns.)

U.S. Pat. No. 5,312,683 by Chou et al. to Minnesota Mining and Manufacturing, “Solvent Coated Metallic Thermal Mass Transfer Donor Sheets”, discloses in Example 1 a Single Layer Silver Color Donor Element made from a solution of 3% Metasheen Silver MSP 1391 coated onto 6 micrometers PET using a #10 Meyer Bar to give an approximate 0.5 micron dry coating thickness. This film was then printed. In Example 5, a dye receptive metallic coating the same as example 4 was prepared on a 4.5 micrometer PET film with antistick backcoat.

U.S. Pat. No. 6,761,788 by DeYoung et al. to Polaroid, “Thermal Mass Transfer Imaging System” discloses in Example II, Col 20 line 26 that donor elements for thermal mass transfer imaging can be prepared as follows: a coating solution can be prepared containing a dye as specified and an appropriate amount of a thermal solvent as specified in 1-butanol. Such a solution can be coated onto a poly(ethylene terephthalate) film base of 4.5 micron thickness with a slip coating for thermal printing on the reverse side, and the coating can be dried.

U.S. Pat. No. 5,318,938 by Hampl, Jr. et al., to Minnesota Mining and Manufacturing, “Thermographic Elements”, discloses that a 10 microns thick film is prepared by casting a 4.5 weight percent solution of FPE polymer (the polymer consisting essentially of, repeating, interpolymerized units derived from 9,9-bis-(4-hydroxyphenyl)-fluorene and isophthalic acid, terephthalic acid or mixtures thereof, the polymer being sufficiently low in oligomer content to allow formation of uniform film, the polymer having a weight average molecular weight of 727,000 and a polydispersivity of 2.2) in methylene chloride and drying the casting. The film is then coated with a coating consisting of 25 weight percent trimethylolpropanetriacrylate dissolved in acetone by wiping a thin coating of the solution on both sides of the film. After air drying, each side of the film is passed under 2 UV lamps under a nitrogen atmosphere at a rate of 50 ft/min. The wattage of the UV lamps is 200 watts/in. Donor elements are prepared from the coated film by applying a composition comprising the components of a dye-donor layer which are dissolved or dispersed in organic solvent. The composition is applied to one side of each element using a number 8 Mayer bar. The wet thickness of each of the coatings is 18 microns (0.72 mil). The coated elements are then dried using forced hot air. One of the donor element is placed in contact with a commercially available base receptor sheet from DaiNippon. The thermal printhead described above is operated in accordance with the procedure described in Examples 1 to 4 of the patent. The other donor element is placed in contact with a receptor sheet, the receptor sheet being prepared by coating a 18 micron (0.72 mil) coating of the image-receiving composition onto one surface of a 0.01 cm (4 mil) thick PET film using a number 8 Mayer bar and forced air drying the resulting coating. Each of the donor elements are passed through the thermal transfer printing apparatus. Both donor elements transport smoothly through the test apparatus, producing minimal or no noise at head voltages of at least 21 volts, causing no stoppage, jamming, tearing, or ripping of the film in the apparatus, and with minimal or no contamination of the printhead at all of the energy levels applied by the printhead. However, the image transfer density of each of the formed images was low. This is probably due to the thickness of the FPE film. These results indicate that the FPE films are useful as donor element substrates in thermal transfer imaging processes.

### SUMMARY OF THE INVENTION

The present invention is a method for thermal mass transfer imaging comprising providing a donor element with a support having a thickness (h) and a modulus (E), an adjacent transfer layer and a receiver element, wherein the receiver element is contacted with the transfer layer to form an assemblage. An imaging head having three or more beams of light is moved relative to the assemblage to cause imagewise mass transfer of the transfer layer onto the receiver element in a local pattern of three or more areas, each area having a local width (b) and local separation (2a) distinct from any adjacent local area, wherein when the modulus is greater than 1.5 and less than or equal to 5 gPa and the local width (b) is less than or equal to 250 microns and the local separation (2a) is less than or equal to 300 microns, the support layer thickness (h) is less than or equal to 45 microns; and wherein when the modulus is greater than 0.05 and less than or equal to 1.5 gPa and the local width (b) is less than or equal to 250 microns and the local separation (2a) is less than or equal to 500 microns, the support layer thickness (h) is less than or equal to 60 microns.

### BRIEF DESCRIPTION OF THE DRAWINGS

FIG. 1 is a cross-sectional cut-away view of an imaged assemblage of one embodiment of the present invention.

FIG. 2A is a cross-sectional view of a prior art donor element.

FIG. 2B is a cross-sectional view of one embodiment of a donor element useful in the present invention.

FIG. 3 is a schematic view of an imaging head with multiple (three) radiation sources.

FIGS. 4A through 4H are schematic cross-sectional views of various embodiments of an assemblage during and after imaging by a radiation source and after separation.

FIG. 5A is a schematic cross-sectional view of irradiation in three locations of a prior art assemblage.

FIG. 5B is a schematic cross-sectional view of irradiation in three locations of one embodiment of an assemblage in the present invention having a thin support layer.

FIG. 6A is a schematic cross-sectional view of an imaged assemblage having a thick support layer after irradiation by the imaging head of FIG. 3.

FIG. 6B is a schematic cross-sectional view of an imaged assemblage having a thin support layer after irradiation by the imaging head of FIG. 3.

FIG. 7 is a chart showing the results of imaging an assemblage with a blue (B) donor element having a 100 micron thick support layer for four sets corresponding to the number of beam positions turned off between the illuminated line features wherein the ordinate value is the blue (B) color value of the transferred feature and the abscissa value is the number of line features imaged.

FIG. 8 is a chart showing the results of imaging an assemblage with a blue (B) donor element having a 25 micron thick support layer for four sets corresponding to the number of beam positions turned off between the illuminated line features wherein the ordinate value is the blue (B) color value of the transferred feature and the abscissa value is the number of line features imaged.

### DESCRIPTION OF THE PREFERRED EMBODIMENT(S)

The invention provides unexpected benefits to thermal mass transfer imaging by a multiple beam imaging head of a donor element that has a flexible support layer as a part of the assemblage with a receiver element being imaged. The benefit is the transfer of an essentially identical mass of transfer layer by each beam, regardless of whether the beam is part of a pattern that has zero, one, two, or more closely neighboring beams.

When thermal transfer imaging an assemblage (of a receiver element and a donor element) by a multiple-feature imaging head to produce a pattern of separate features, the separate features created by the imaging head can have unintended differing characteristics beyond the feature design. It is beneficial to minimize the magnitude of these differences. In at least the case where thermal transfer imaging uses beams from an imaging head that produces a significant volume change in the assemblage of a donor element and a receiver held in contact by a force, these characteristics can surprising vary depending on whether the specific feature is created by a beam isolated or outermost on the imaging head (thus having zero or one closely neighboring beam), or by an inner beam having two or more closely neighboring beams. There is an unexpected benefit of decreasing the difference in characteristics of the imaging result for each beam by using a donor element that has a more flexible support layer in comparison to the result obtained using a donor element with a stiffer support layer. A common measurement of flexibility and stiffness is Young's modulus, also known as tensile elastic modulus or modulus of elasticity. Young's modulus is the ratio of stress to strain below the elastic limit. Young's modulus as used here corresponds to that determined by ASTM E111-04, “Standard Test Method for Young's Modulus, Tangent Modulus and Chord Modulus” or equivalent.

Flexibility of the support layer can be increased, for example, by the selection of the material used e.g., selecting a material with a lower Young's modulus, for example using low Young's modulus polyethylene (PE) instead of high Young's modulus polyethylene terephthalate (PET)) or by a thickness decrease of the material used (e.g., use 1 mil thick polyethylene terephthalate rather than 4 mil thick PET), or by both (e.g. using 1 mil PE rather than 2 mil PET). An additional benefit of choosing a thinner or more flexible support layer is that line edge roughness can decrease.

It is believed that one explanation of these benefits of flexible support layer in a donor element could be related to imaging of an assemblage of a donor element and a receiver element causing a small separation of the donor element from the receiver element in the vicinity of the irradiated pattern, termed the excess assemblage separation. This might be due to pressure generated during imaging. Resisting this separation might be a pressure holding together the donor element and the receiver element, or inertia of the donor element or receiver element towards movement. Although these factors may be one explanation of the causes or benefits of a flexible support layer, this explanation is not intended to restrict the invention by any element or limitation based upon such an explanation.

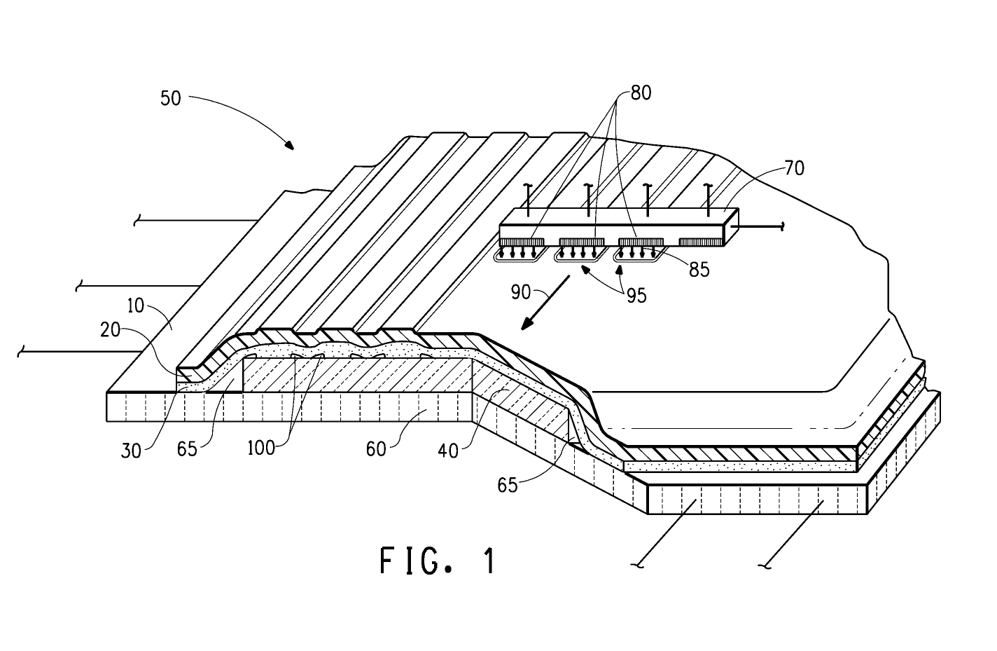

One embodiment of the present invention is shown in FIG. 1, a cut away view of a portion of an assemblage being imaged. A donor element 10 comprises a flexible support layer 20 (e.g. a 35 micron thick polyethylene terephthalate film) and an adjacent transfer layer 30 (e.g. a 2 micron thick layer of pigment and near-IR-absorbing dye in binder). The transfer layer 30 is aligned in contact with an adjacent receiver element 40 (e.g. a color filter array substrate of glass and a black mask), forming an assemblage 50 that can be imaged. A means of aligning with force positions the donor element adjacent to the receiver element (e.g. a vacuum table 60 aligns by removing air through openings 65 from between the receiver element and the transfer layer of the donor element), bringing the receiver element and transfer layer of the donor element into contact (intermittent or complete). A means of imaging with multiple beams of radiation (e.g. a laser imaging head 70) moves over and heats the assemblage according to a pattern. The heating produces a force that transfers a mass of transfer layer from the donor element to the receiver element according to the pattern, and also causes a partial separation of the transfer layer from previous alignment with the receiver element, for example in an area including and adjoining the imaged areas of the pattern. For example a multiple-beam imaging head 70 moving in a direction 90 relative to the assemblage provides multiple simultaneous beams of imaging radiation 85 from multiple radiation sources 80 that cause transfer of transfer layer within the illuminated pattern 95, and a partial separation of the transfer layer from the receiver element outside the illuminated pattern of imaging as illustrated later. After imaging, the spent donor element and imaged receiver element bearing the pattern of transfer layer can be fully separated.

In all Figures, objects are not necessarily drawn to scale but are illustrative of positioning. For example, the width and length scales generally encountered are vastly larger than the height or thickness scale. To illustrate, the receiver element can comprise a glass sheet of 2 millimeter thickness and length and width greater than a meter; while the donor element can comprise a support layer of 50 microns thickness and a transfer layer of 1.5 microns thickness, with length and width greater than a meter. An imaging head might be 4 millimeters wide and comprise 200 separate beams arranged in a line, moved over a meter in a scan.

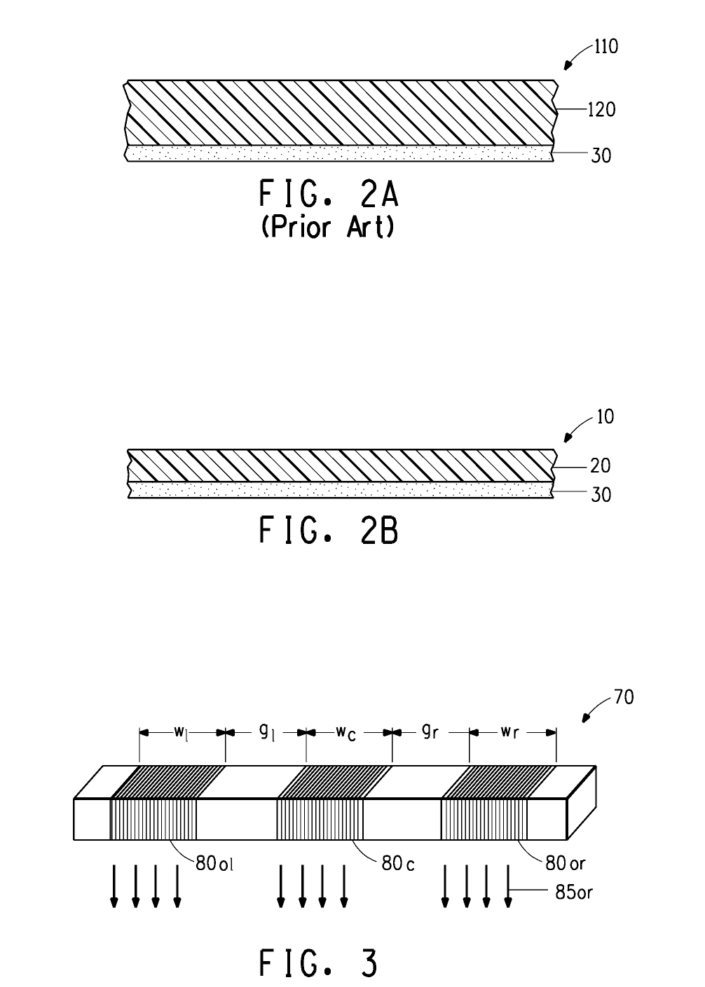

FIG. 2A shows in cross-section a known donor element 110 having a transfer layer 30 and an adjacent thick support layer 120 of relatively low flexibility material. FIG. 2B shows an embodiment of the present invention useful in a donor element 10 comprising a transfer layer 30 and an adjacent flexible support layer 20. In one embodiment, the flexible support layer is thin; in another embodiment, the flexible support layer comprises a flexible, low modulus material such as polyethylene.

FIG. 3 schematically illustrates an imaging head 70 with multiple (three) radiation sources 80. An inner source 80c with a width we has a right outside neighbor 80 or of width wr separated from 80c by a gap gr, and a left outside neighbor 80ol with a width wl separated from 80c by a gap gl. It is clear from this illustration that the imaging head 70 holds at least two distinguishable types of radiation sources; when the configuration of neighboring radiation sources is considered: a type having a near neighbor and a distant neighbor on one side, but no neighbors on the other side, and a type having a near neighbor on two opposite sides.

In an embodiment where movement of the imaging head 70 (or analogous heads with more inner sources similarly aligned) produces a pattern of equal parallel lines spaced apart by a constant amount, the pattern is called “lines and spaces”, with lines of a given width and spaces of a given gap distance.

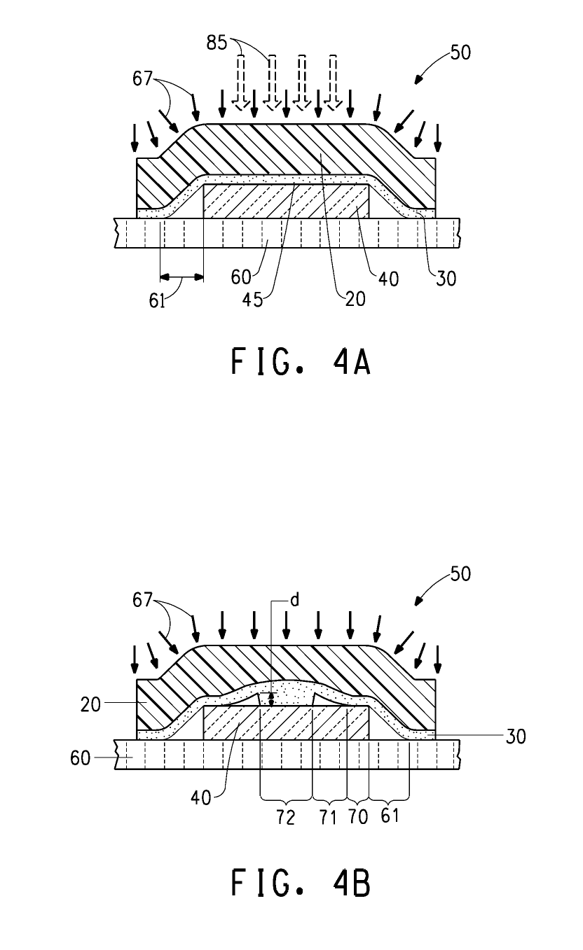

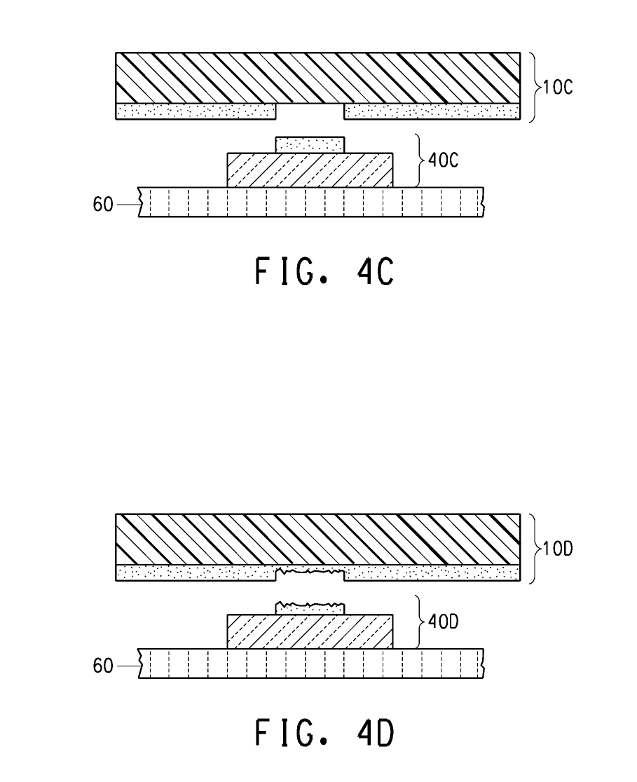

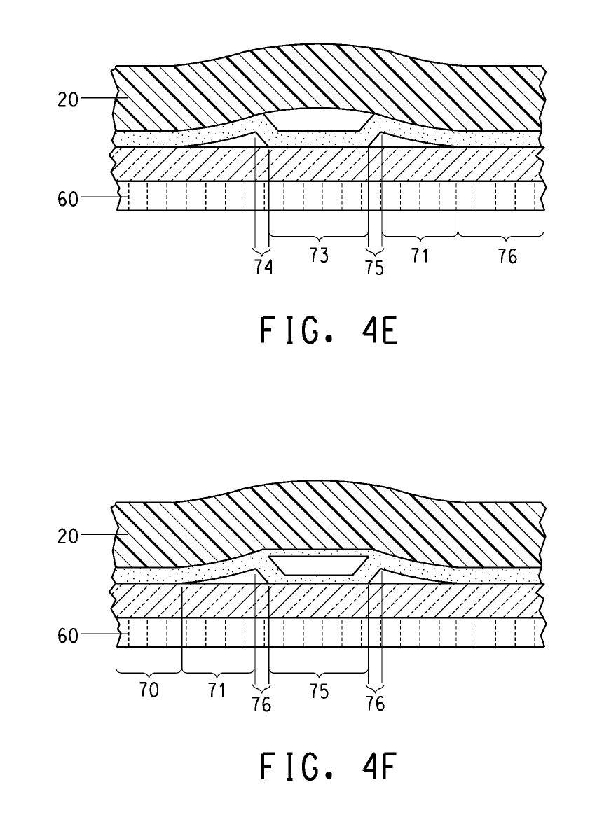

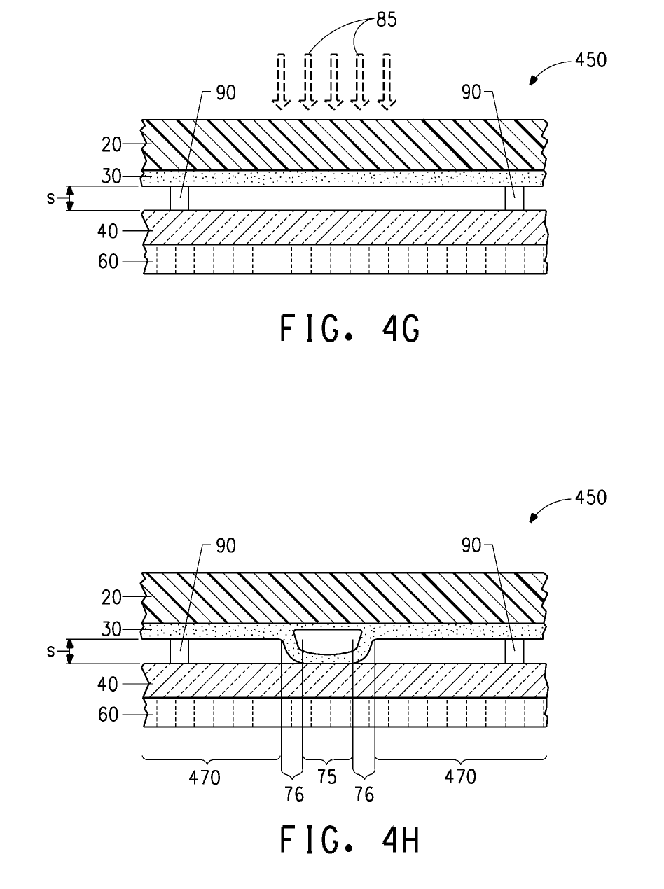

FIG. 4A through 4H schematically illustrate various examples of a cross section of an assemblage during and after imaging by a radiation source and after separation. In FIG. 4A, an assemblage 50 comprises a vacuum table 60 supporting a receiver element 40 having a flat upper surface 45 covered by a transfer layer 30 adjacent a support layer 20. The donor element, made up of the transfer layer 30 and the support layer 20, drapes over the receiver element in region 61 as the donor element comes into contact with the vacuum table. While the vacuum table is removing the atmosphere from any volume between the donor element and the receiver element, the evacuation leads to a force 67 moving the donor element closer to the receiver element and the vacuum table. In the case of a flat receiver element and a typical donor element, excellent contact can be made. Typically the contact is reversible; if the support layer 20 is moved away from the receiver element 40, the transfer layer 30 remains entirely with the support layer.

Also shown in FIG. 4A is a beam of radiation 85 that impinges on the closely aligned assemblage 50 of the donor element 10 comprising the support layer 20 and the transfer layer 30 adjacent the receiver element 40. The radiation is sufficient in amount to cause heating of the assemblage, so that upon sufficient and appropriate heating, the transfer of transfer layer to the receiver. Reversible disassembly of the assemblage is no longer possible.

In the embodiment of FIG. 4B, the transfer layer expands in volume (area 72) in the area heated sufficiently by the impinging radiation, creating a separation of the neighboring unaffected transfer layer (area 71) from the receiver element, in contrast with a remote undisturbed region (area 70) where the transfer layer and receiver element are in the same positions as before imaging. The areas 71 and 72 together constitute an area of separation of the support layer from the receiver element (excess assemblage separation, shown as “d”), which can alternatively be termed an area of disturbance, generated by the imaging.

Explanations of volume expansion include thermal expansion during heating, and formation of bubbles and voids. The expansion may be temporary, semipermanent, or permanent. In one embodiment, the expansion in area 72 causes an increase in adhesion between the transfer layer and the receiver element, or in another embodiment a decrease in adhesion between the transfer layer and the support layer can occur, or a decrease in cohesive strength of the transfer layer. The expansion in area 72 separates the support layer from the receiver layer, while the force holding together the assemblage tends to keep the support layer and receiver layer in their original, pre-imaging relationship as in area 70. In the intermediate area 71, the support layer and receiver element are separated from each other by a distance “d” and the transfer layer remains undisturbed on the support layer and thus is separated from the receiver element relative to their positioning in the undisturbed assemblage.

FIG. 4C illustrates one result of separation of a spent donor element 10C from an imaged receiver element 40C. Separation is typically accomplished by removing the force holding the donor element in contact with the receiver element and separating the support element 20 from the rest of the assemblage. Peeling is one common technique. During the separation, the transfer layer partitions between the donor element and the receiver element. FIG. 4C illustrates the total thickness of transfer layer in the area of irradiation has cleanly separated from the donor element and remains on the receiver element.

FIG. 4D illustrates another result of separation of a spent donor element 10D from an imaged receiver element 40D. FIG. 4D illustrates a portion of the thickness of transfer layer in the area of irradiation has separated from the donor element and remains on the receiver element, but that the transfer layer thickness nearest the support layer remains with the support layer. One mechanism for this partitioning is cohesive failure due to a change in the strength of the transfer layer, rather than adhesive failure at the attachment point of the transfer layer to the donor element.

In another embodiment shown in FIG. 4E, in the area of transfer by irradiation the support layer 20 has separated from the transfer layer that is now in contact with the receiver element (area 73), creating a region where the transfer layer is separated from both the donor element and the receiver element (area 74), a region where the transfer layer is in contact with the support layer and separated from the receiver element (area 71), and a remote undisturbed region (area 70). Separation of this assemblage could produce a spent donor and imaged receiver similar to those shown in FIG. 4C.

In another embodiment shown in FIG. 4F, irradiation produces a cohesive failure of the transfer layer and a relative separation of the support layer away from the receiver element. In the region of transfer by irradiation (area 75), a portion of transfer layer is in adhesive contact with the receiver element and a portion of the transfer layer is in adhesive contact with the support layer of the donor element. A first transition region (area 76) can exist where a portion of the transfer layer is not in adhesive contact with either the receiver element or the support. A second transition region can exist where the transfer layer is in contact with the support layer and separated from the receiver element (area 71), and a remote undisturbed region (area 70) can also exist. Separation of this assemblage could produce a spent donor and imaged receiver similar to those shown in FIG. 4D.

FIG. 4G shows a cross section 450 of an assemblage in a region of slight separation by a minimum gap distance “s” of the aligned transfer layer 30 and the receiver element 40. Such a separation can be maintained by spacers 90, for example on an imaged receiver element having transfer layer received from imaging of a prior assemblage. When the support layer of the donor element is relatively stiff, it can bridge the distance between spacers without coming into contact with the surface of the receiver element.

FIG. 4H shows a cross-section of the assemblage 450 after imaging. Notable is the lack of movement of the support layer 20, since movement or expansion of the donor element due to irradiation was accommodated by the minimum gap distance s. This need not be true; if the gap s is insufficient to accommodate the expansion, a separation of the support layer away from the receiving element can occur. FIG. 4F illustrates a transfer mode analogous to that of FIG. 4F, wherein some portion of transfer layer remains associated with the donor element in the area of irradiation, and some portion of transfer layer transfers.

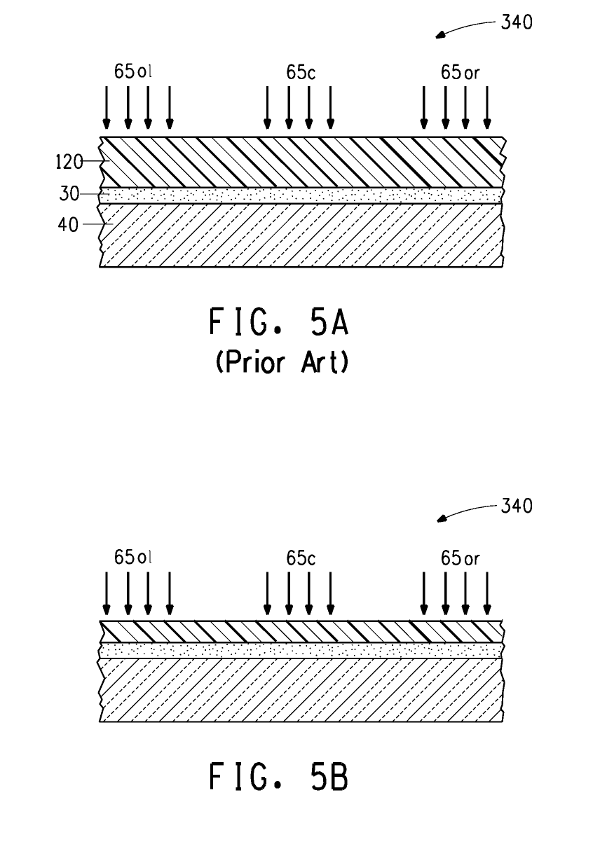

FIG. 5A shows schematically the irradiation in three locations (65ol, 65c, 65or) of a known assemblage having a thick, relatively stiff support layer 120. For the sake of simplification, the vacuum table and vectors of force due to evacuation are not shown. FIG. 5B shows the same irradiation of an embodiment of the invention having a thin, flexible support layer.

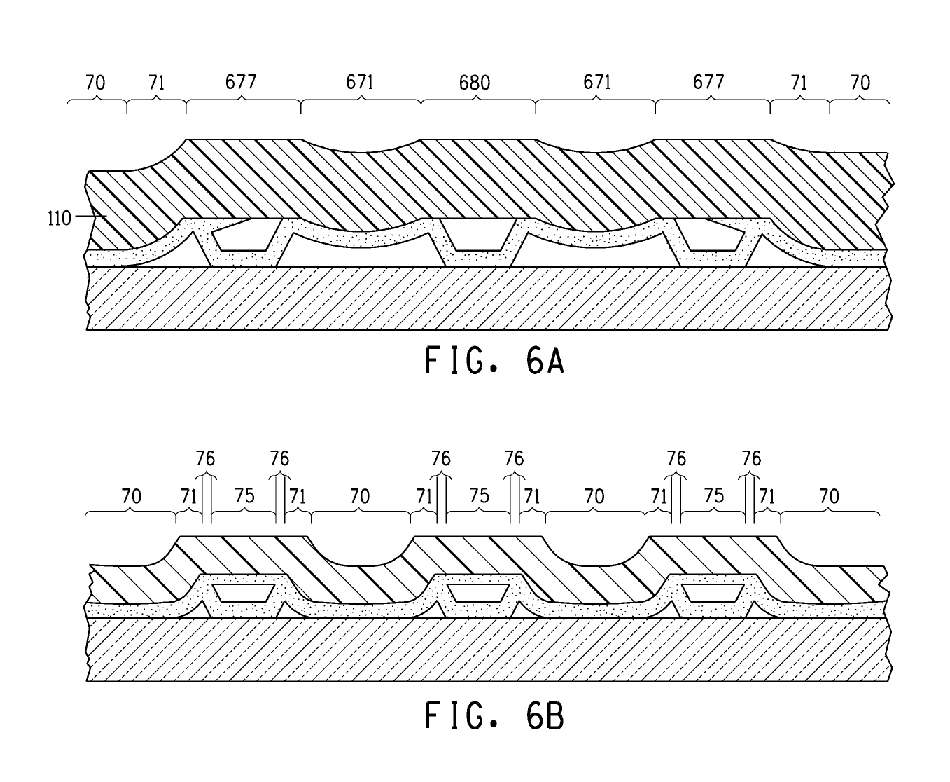

FIGS. 6A and 6 B show how near the time of irradiation (that produces movement of the support layer relative to the receiver layer), the neighboring areas of irradiation can remain isolated or interact with one another. FIG. 6A shows an example of interaction of neighboring areas of irradiation. FIG. 6A illustrates an imaged assemblage with a thick, relatively inflexible support layer 110 after imaging irradiation by a head of FIG. 3. On the left side of the figure, moving towards the right, first lies a remote undisturbed region (area 70) of the assemblage where the transfer layer is aligned in contact with the receiver element 40, followed by a region of separation (area 71) where the transfer layer outside the irradiated pattern remains in adhering contact with the support layer but is separated from the receiver element due to movement of the support layer caused by irradiation. Moving further to the right, there is a region of irradiation-induced transfer where at least a portion of the transfer layer has transferred to the receiver element (area 677). In area 677, the amount of transfer layer still adhesively contacting the support layer of the donor element decreases on the side closest to a neighboring pattern area, due to the support layer having been moved farther away from the receiver element as a result of the combined movement of two areas (677, 680) of irradiated pattern. Continuing rightward movement from region 677, there is a region where the movement of the support layer in areas 677 and 688 has overcome the force bringing the donor element and the receiver element together, so that the unirradiated donor element is separated from the receiver element 671 rather than being in contact as was true prior to irradiation. Continuing rightward movement from the separated elements 671, in the area 680 irradiated by an inner beam 80c, transfer occurs differently than for area 677 because of the symmetry of the influence of the neighboring regions of irradiation.

In FIG. 6B, an assemblage comprising a thin flexible support layer was irradiated using the same head of FIG. 3 as for FIG. 6A. In this case, the thin flexible support layer isolates each region of irradiation from the effect of movement of its neighbor(s). In moving from left to right there occur a region of undisturbed alignment 70, followed by a region of separation 71 where the transfer layer outside the irradiated pattern remains in adhering contact with the support layer element but is separated from the receiver element due to movement of the support layer caused by irradiation, followed by a region where at least a portion of the transfer layer is separated from both the donor element and the receiver element (area 76), and in the area of irradiation a portion of the transfer layer is now in contact with the receiver element (area 75), followed by an unirradiated region 71 where the transfer layer outside the irradiated pattern remains in adhering contact with the support layer element but is separated from the receiver element due to movement of the support layer caused by irradiation, and finally a region of undisturbed alignment 70 isolating the effects of irradiation of this transferred region. The local environment about each area of irradiation is indistinguishable from another and unaffected by the presence of neighbors, a result of the thin flexible support layer restoring the assemblage to its unaltered state in the region between all neighboring regions of irradiation. No region like 671 is encountered, where lifting from one area of irradiation is joined to lifting from another area of irradiation.

The unexpected benefit of thin flexible support layer in a donor element has not been recognized in the known art. Thin flexible bases have at least this important benefit: in the transfer of equal or similar amounts of transfer layer regardless of arrangement of lines and spaces on the imaging head. This utility becomes more pronounced as the unirradiated regions between areas of irradiation become smaller.

The specific elements and methods illustrated in the Figures and their description follow. The donor element 10 comprises a flexible support layer 20 and an adjacent transfer layer 30. In one embodiment, the flexible support layer 20 is a thin polymer film. The support layer is chosen to be sufficiently thin and sufficiently flexible so as to decrease or minimize the area affected by the separation of the donor element and receiver element of the assemblage during imaging, by virtue of the flexibility of the support returning the assemblage to an undisturbed state within a small distance of an area of imaging. This choice allows a wider range of features and feature separations to be imaged by a multiple-beam imaging head.

The support layer 20 provides a practical means of handling the donor element with its functional layers, for example during manufacturing, in making the imagable assemblage, and in removing the spent donor element from the imaged receiver element after imaging of the assemblage. In such aspects, the support layer is conventional, acting as a substrate for layers that may be substantially changed during imaging.

The support layer preferably has flexibility, good dimensional stability, and heat resistance sufficient to avoid or withstand significant damage at the temperatures achieving during the thermal imaging. Examples of the materials suitable for the support layer include synthetic resins, e.g. polyethylene terephthalate, polyethylene-2,6-naphthalate, polystyrene, polycarbonates such as 4,4′-iso-propylidenediphenol polycarbonate, polymethyl methacylate, polyethylene, polypropylene, polyvinyl chloride, polyvinylidene chloride, styrene-acrylonitrile copolymer, polyamide(s) such as Nylon 6,6, polyimide(s), polyamideimide, nitrocellulose, and polyethersulfone. In one embodiment the support layer comprises a biaxially stretched polyester, particularly polyethylene terephthalate.

The Young's modulus (E, elastic modulus) of certain support layer materials is approximately 2-2.5 gPa (gigapascal) for polyethylene terephthalate, 3-3.5 gPa for polystyrene, 1.8-3.1 gPa for polymethyl methacrylate, 2-2.2 gPa for 4,4′-iso-propylidenediphenol polycarbonate (e.g. LEXAN from General Electric, Schenectady, N.Y.), 1 gPa for ultrahigh molecular weight polyethylene, 0.17-0.28 gPa for low density polyethylethylene, 1.3-1.5 gPa for nitrocellulose, 2-4 gPa for polyvinyl chloride, 2.7 gPa for polyethersulfone. A suitable Young's modulus for the support layer is from 0.1 to 12 gPa. In one embodiment, a material having a small Young's modulus is chosen to allow features to be written with identical or very similar attributes in a single writing pass of a multifeature-writing head; for example the support layer Young's modulus can be chosen from about or between 0.1, 0.3, 0.5, 0.75, 1.0, 1.3, 1.4, 1.5, 1.6, 1.7, 1.8, 1.9, 2.0, 2.1, 2.2, 2.3, 2.4, 2.5, 2.7, 3.0, 4.0, 5.0, 6.0, and 8.0 gPa. It is generally true that for a given thickness of a donor element support layer material, that a lower Young's modulus (a more flexible or elastic material) contributes to a smaller area of disturbance around the area imaged in the assemblage. The disturbance created is the separation of the donor element and the receiver element relative to their spacing before imaging. However, although a lower Young's modulus material is preferred, the choice of material is often influenced by other factors and a compromise is found. A support layer with a higher Young's modulus can simplify handling of the donor element.

The thickness of the support layer also influences the size of the area of disturbance around the area imaged in the assemblage. For a given material used as the support layer (a constant Young's modulus), a thinner support layer means a more flexible assemblage and a smaller area of disturbance. Suitable support layer thickness can be about or less than 100, 60, 45, 40, 35, 30, 25, 20, 15, 10, 8, 6, 4, and 2 microns; and about or greater than 1, 3, 7, 10, 15, 20, 25, 30, 40, 45, 55, 75, and 100 microns. However, although a thinner support layer material is preferred, the support layer thickness is often influenced by other factors such as handling and availability and a compromise is found.

The support layer may comprise one or more discrete layers of the above film-forming materials. The polymeric materials of the respective layers may be the same or different. For instance, the support layer may comprise one, two, three, four or five or more layers and typical multi-layer structures may be of the AB, ABA, ABC, ABAB, ABABA or ABCBA type.

Formation of the support layer may be accomplished by conventional techniques. Conveniently, formation of the support layer is effected by extrusion. In general terms the process may comprise the steps of extruding a layer of molten polymer, quenching the extrudate and orienting the quenched extrudate in at least one direction.

The support layer may be unoriented, or oriented any number of times, for example uniaxially-oriented, or biaxially-oriented. Orientation may be effected by any process known in the art for producing an oriented film, for example a tubular or flat film process. Biaxial orientation may be effected by drawing in two mutually perpendicular directions in the plane of the film to achieve a satisfactory combination of mechanical and physical properties.

Simultaneous biaxial orientation may be effected by extruding a thermoplastic polymer tube, which is subsequently quenched, reheated and then expanded by internal gas pressure to induce transverse orientation, and withdrawn at a rate, which will induce longitudinal orientation.

The support layer-forming polymer may be extruded through a slot die and rapidly quenched upon a chilled casting drum to ensure that the polymer is quenched to the amorphous state. Orientation then may be effected by stretching the quenched extrudate in at least one direction at a temperature above the glass transition temperature of the polyester. Sequential orientation may be effected by stretching a flat, quenched extrudate firstly in one direction, usually the longitudinal direction, i.e. the forward direction through the film-stretching machine, and then in the transverse direction. Forward stretching of the extrudate may be conveniently effected over a set of rotating rolls or between two pairs of nip rolls, transverse stretching then being effected in a stenter apparatus. Alternatively, the cast film may be stretched simultaneously in both the forward and transverse directions in a biaxial stenter. Stretching is effected to an extent determined by the nature of the polymer, for example polyethylene terephthalate is usually stretched so that the dimension of the oriented film is from 2 to 5, more preferably 2.5 to 4.5, times its original dimension in each direction of stretching. Typically, stretching is effected at temperatures in the range of 70 to 125° C. Greater draw ratios (for example, up to about 8 times) may be used if orientation in only one direction is required. It is not necessary to stretch equally in each direction although this is common.

Where the support layer itself comprises more than one layer, preparation of the support layer may be conveniently effected by coextrusion, either by simultaneous coextrusion of the respective film-forming layers through independent orifices of a multi-orifice die, and thereafter uniting the still molten layers, or, alternately, by single-channel coextrusion in which molten streams of the respective polymers are first united within a channel leading to a die manifold, and thereafter extruded together from the die orifice under conditions of streamline flow without intermixing thereby to produce a multi-layer polymeric film, which may be oriented and heat-set as herein described. Formation of a multi-layer support layer may also be effected by conventional lamination techniques, for example by laminating together a preformed first layer and a preformed second layer, or by casting, for example, the first layer onto a preformed second layer.

The support layer is typically coatable so that uniform coatings such as of the transfer layer precursor formulation can be conveniently applied and concentrated into layers, and the final multilayer donor element can be conveniently handled in sheet or roll form. The support layer composition is also typically selected from materials that remain sufficiently stable despite heating of the light-to-heat conversion layer during imaging.

The materials used to form the outmost surfaces on the side of the support layer towards the transfer layer can be selected to improve adhesion between the support layer and the next adjacent layer, or to control temperature transport between the support layer and the adjacent layer, or to control imaging light transport to the light-to-heat conversion layer, or to improve handling of the donor element, and the like (individually or in combination). An optional priming layer can be used to increase uniformity during the coating of subsequent layers onto the support layer and also increase the bonding strength between the support layer and adjacent layers. One example of a suitable support layer with primer layer is available from Teijin Ltd. (Product No. HPE100, Osaka, Japan).

The support layer may be plasma-treated to accept an adjacent contiguous layer, such for offerings in the MELINEX® line of polyester films made by DuPont Teijin Films®, a joint venture of DuPont and Teijin Limited. Backing layers on back side of the support layer opposite the transfer layer may optionally be provided on the support layer. These backing layers may contain fillers to provide a roughened surface on the back side of the support layer, i.e., the side opposite from the transfer layer. Alternatively, the support layer itself may contain fillers incorporated into the support layer matrix, such as silica, to provide a roughened surface on the back side of the support layer. Alternatively, the support layer may be physically roughened to provide a roughened surface on one or both surfaces of the support layer. Some examples of physical roughening methods include sandblasting, impacting with a metal brush, etc. A light-attenuating layer may result from a roughened support layer surface or surface layer, which can also include a light-attenuating agent such as an absorber or diffuser.

The support layer may contain any of the additives conventionally employed in the manufacture of polymeric films, such as voiding agents, lubricants, anti-oxidants, radical scavengers, UV absorbers, fire retardants, thermal stabilizers, anti-blocking agents, surface active agents, slip aids, optical brighteners, gloss improvers, pro-degradents, viscosity modifiers and dispersion stabilizers. Fillers are particularly common additives for polymeric film and useful in modulating film characteristics, as is well known in the art. Typical fillers include particulate inorganic fillers (such as metal or metalloid oxides, clays and alkaline metal salts, such as the carbonates and sulfates of calcium and barium) or incompatible resin fillers (such as polyamides and polyolefins) or a mixture of two or more such fillers, as are well-known in the art and described in WO-03/078512-A for example, that is herein incorporated by reference. The components of the composition of a layer may be mixed together in a conventional manner. For example, by mixing with the monomeric reactants from which the layer polymer is derived, or the components may be mixed with the polymer by tumble or dry blending or by compounding in an extruder, followed by cooling and, usually, commination into granules or chips. Masterbatching technology may also be employed.

The support layer is preferably unfilled or only slightly filled, i.e. any filler is present in only small amounts, generally not exceeding 0.5% and preferably less than 0.2% by weight of the support layer polymer. In this embodiment, the support layer will typically be optically clear, preferably having a percentage of scattered visible light (haze) of less than about 6%, more preferably less than about 3.5% and particularly less than about 2%, measured according to the standard method ASTM D 1003.

The support layer is usually reasonably transparent to the imaging light, which impinges on it prior to reaching other portions of the assemblage such as the transfer layer or a light-to-heat conversion layer. For example in one embodiment a support layer having a light transmittance at the imaging wavelengths of about 90% or more is useful. Also, an antireflection layer may be formed generally on either side of the support layer to reduce light reflection.

Metallized films can be used as a support layer for a donor element. Specific examples include single or multilayer films comprising polyethylene terephthalate or polyolefin films. Useful polyethylene terephthalate films include MELINEX® 473 (100 μm thickness), MELINEX® 6442 (100 μm thickness), MELINEX® LJX111 (25 μm thickness), and MELINEX® 453 (50 μm thickness), all metallized to 50% visible light transmission with metallic chromium by CP Films, Martinsville, Va.

In one embodiment, the support layer is sufficiently transparent to the imaging radiation that the assemblage is illuminated on the support layer side of the assemblage rather than on the receiver element side. It is much more often practiced to use a sufficiently transparent support layer and illuminate the assemblage through the support layer, however the advantages of the present invention are not dependent on the direction of illumination, and should work equally well for either direction.

The transfer layer 30 of FIG. 1 serves to hold transferable material. In a typical donor element, there is at least one layer included in the transfer layer; and more than one layer can make up the transfer layer. The transfer layer has an inner side and an outer side. The outer side of said transfer layer is placed adjacent to a receiver element of an imagable assemblage for image-wise transfer by light. Transfer layers can include any suitable material or materials that are disposed in one or more layers with or without a binder that can be selectively transferred. The transfer can occur as a unit, in portions or in part by any suitable transfer mechanism. The transfer occurs when the assemblage is exposed to imaging light that can be absorbed by the absorbers in the assemblage and at least some portion of the electromagnetic light energy is converted into heat. In image-wise transfer, the transferred material need not be the entire mass of the transfer layer. Components of the transfer layer in a single portion may be selectively transferred to the receiver element while other components are retained with the donor element (e.g. a sublimable dye may transfer while a heat resistant crosslinked polymer matrix holding the dye may remain untransferred).

The transfer layer may be of any thickness, which remains functional for transfer to the receiver element and to fulfill the necessary function on the imaged receiver element or the donor element. Typical thickness of a transfer layer may be from about 0.1 μm to about 20 μm; for example, 0.2, 0.5, 0.8, 1, 2, 4, 6, 8, 10, 15, or 20 μm.

The transfer layer may include multiple components including organic, inorganic, organometallic, or polymeric materials. Examples of materials that can selectively patterned from donor elements as transfer layers and/or as materials incorporated in transfer layers include colorants (e.g., pigments and/or dyes dispersed in a binder), polarizers, liquid crystal materials, particles (e.g., spacers for liquid crystal displays, magnetic particles, insulating particles, conductive particles), emissive materials (e.g., phosphors and/or organic electroluminescent materials), non-emissive materials that may be incorporated into an emissive device (for example, an electroluminescent device) hydrophobic materials (e.g., partition banks for ink-jet receptors), hydrophilic materials, multilayer stacks (e.g., multilayer device constructions such as organic electroluminescent devices), microstructured or nanostructured layers, etch-resist, metals, materials having a metal component, polymers, adhesives, binders, and bio-materials, and other suitable materials or combination of such materials.

The transfer layer can be applied by coating onto the support layer, or other suitable donor element layer adjacent to the support layer. The transfer layer or its precursor may be applied by any suitable technique for coating a material such as, for example, bar coating, gravure coating, extrusion coating, vapor deposition, lamination and other such techniques. Prior to, after, or simultaneously with coating, a cross-linkable transfer layer material or portions thereof may be crosslinked, for example by heating, exposure to radiation, and/or exposure to a chemical curative, depending upon the material.

In one embodiment, the transfer layer includes material that is useful in display applications. Thermal transfer according to the present invention can be performed to pattern one or more materials on a receiver element with high precision and accuracy using fewer processing steps than for photolithography-based patterning techniques, and thus can be especially useful in applications such as display manufacture. For example, transfer layers can be made so that, upon thermal transfer to a receiver element, the transferred materials form color filters, black matrix, spacers, barriers, partitions, polarizers, retardation layers, wave plates, organic conductors or semi-conductors, inorganic conductors or semi-conductors, organic electroluminescent layers, phosphor layers, organic electroluminescent devices, organic transistors, and other such elements, devices, or portions thereof that can be useful in displays, alone or in combination with other elements that may or may not be patterned in a like manner.

In particular embodiments, the transfer layer can include a colorant. Pigments or dyes, for example, may be used as colorants. In one embodiment, pigments having good color permanency and transparency such as those disclosed in the NPIRI Raw Materials Data Handbook, Volume 4 (Pigments), are used. Examples of suitable transparent colorants include Ciba-Geigy Cromophtal Red A2B®, DAINICH-Seika ECY-204®, Zeneca Monastral Green 6Y-CL®, and BASF Heliogen Blue L6700®. Other suitable transparent colorants include Sun RS Magenta 234-007®, Hoechst GS Yellow GG 11-1200®, Sun GS Cyan 249-0592®, Sun RS Cyan 248-061, Ciba-Geigy BS Magenta RT-333D®, Ciba-Geigy Microlith Yellow 3G-WA®, Ciba-Geigy Microlith Yellow 2R-WA®, Ciba-Geigy Microlith Blue YG-WA®, Ciba-Geigy Microlith Black C-WA®, Ciba-Geigy Microlith Violet RL-WA®, Ciba-Geigy Microlith Red RBS-WA®, any of the Heucotech Aquis II® series, any of the Heucosperse Aquis III series, and the like. Another class of pigments than can be used for colorants in the present invention is the various latent pigments such as those available from Ciba-Geigy. Transfer of colorants by thermal imaging is disclosed in U.S. Pat. Nos. 5,521,035; 5,695,907; and 5,863,860 and is herein incorporated by reference.

In some embodiments, the transfer layer can include one or more materials useful in emissive displays such as organic electroluminescent displays and devices, or phosphor-based displays and devices. For example, the transfer layer can include a crosslinked light emitting polymer or a crosslinked charge transport material, as well as other organic conductive or semi-conductive materials, whether crosslinked or not. For organic light emitting diodes (OLEDs) that are polymeric, it may be desirable to crosslink one or more of the organic layers to enhance the stability of the final OLED device. Crosslinking one or more organic layers for an OLED device prior to thermal transfer may also be desired. Crosslinking before transfer can provide more stable donor media, better control over film morphology that might lead to better transfer and/or better performance properties in the OLED device, and/or allow for the construction of unique OLED devices and/or OLED devices that might be more easily prepared when crosslinking in the device layer(s) is performed prior to thermal transfer.

Examples of light emitting polymers include poly(phenylenevinylene)s (PPVs), poly-para-phenylenes (PPPs), and polyfluorenes (PFs). Specific examples of crosslinkable light emitting materials that can be useful in transfer layers of the present invention include the blue light emitting poly(methacrylate) copolymers disclosed in Li, et al., Synthetic Metals 84, pp. 437-438 (1997), the crosslinkable triphenylamine derivatives (TPAs) disclosed in Chen, et al., Synthetic Metals 107, pp. 203-207 (1999), the crosslinkable oligo- and poly(dialkylfluorene)s disclosed in Klarner, et al., Chem. Mat. 11, pp. 1800-1805 (1999), the partially crosslinked poly(N-vinylcarbazole-vinylalcohol) copolymers disclosed in Farah and Pietro, Polymer Bulletin 43, pp. 135-142 (1999), and the oxygen-crosslinked polysilanes disclosed in Hiraoka, et al., Polymers for Advanced Technologies 8, pp. 465-470 (1997).

Specific examples of crosslinkable transport layer materials for OLED devices that can be useful in transfer layers of the present invention include the silane functionalized triarylamine, the poly(norbornenes) with pendant triarylamine as disclosed in Bellmann, et al., Chem. Mater. 10, pp. 1668-1678 (1998), bis-functionalized hole transporting triarylamine as disclosed in Bayerl, et al., Macromol. Rapid Commun. 20, pp. 224-228 (1999), the various crosslinked conductive polyanilines and other polymers as disclosed in U.S. Pat. No. 6,030,550, the crosslinkable polyarylpolyamines disclosed in International Publication WO 97/33193, and the crosslinkable triphenyl amine-containing polyether ketone as disclosed in Japanese Unexamined Patent Publication Hei 9-255774.

Light emitting, charge transport, or charge injection materials used in transfer layers of the present invention may also have dopants incorporated therein either prior to or after thermal transfer. Dopants may be incorporated in materials for OLEDs to alter or enhance light emission properties, charge transport properties and/or other such properties.

Thermal transfer of materials from donor sheets to receiver elements for emissive display and device applications is disclosed in U.S. Pat. Nos. 5,998,085 and 6,114,088, and in PCT Publication WO 00/41893.

The transfer layer can optionally include various additives. Suitable additives can include light absorbers such as IR absorbers, UV absorbers, or visible light absorbers; dispersing agents, surfactants, stabilizers, plasticizers, crosslinking agents and coating aids. The transfer layer may also contain a variety of additives including but not limited to dyes, plasticizers, UV stabilizers, film forming additives, and adhesives. Suitable light absorbers for the transfer layer, and their conditions of use, are the same as those discussed in the section on the optional light-to-heat conversion layer.

It is typical for a transfer layer with a binder that any polymers of the binder do not undesirably self-oxidize, decompose or degrade at the temperature achieved during the heat exposure so that the exposed areas of the transfer layer are undamaged. Examples of suitable binders include styrene polymers and copolymers, including copolymers of styrene and (meth)acrylate esters and acids, such as styrene/methyl-methacrylate and styrene/methyl-methacrylate/acrylic-acid, copolymers of styrene and olefin monomers, such as styrene/ethylene/butylene, and copolymers of styrene and acrylonitrile; fluoropolymers; polymers and copolymers of (meth)acrylic acid and the corresponding esters, including those with ethylene and carbon monoxide; polycarbonates; polysulfones; polyurethanes; polyethers; and polyesters. The monomers for the above polymers can be substituted or unsubstituted. Mixtures of polymers can also be used. Other suitable binders include vinyl chloride polymers, vinyl acetate polymers, vinyl chloride-vinyl acetate copolymers, vinyl acetate-crotonic acid copolymers, styrene maleic anhydride half ester resins, (meth)acrylate polymers and copolymers, poly(vinyl acetals), poly(vinyl acetals) modified with anhydrides and amines, hydroxy alkyl cellulose resins and styrene acrylic resins.

One or more other conventional thermal transfer donor element layers can be included in the donor element of the instant invention, including but not limited to an interlayer, release layer, ejection layer, light-to-heat conversion layer, and thermal insulating layer.

An optional light-to-heat conversion layer in a donor element serves to convert imaging light into heat that contributes to or causes the imaging to occur. The light-to-heat conversion layer is typically situated between the support layer and the transfer layer. The function of the light-to-heat conversion layer depends on the inclusion of a light absorber.

Typically, a light absorber in the light-to-heat conversion layer or transfer layer absorbs light in the infrared, visible, and/or ultraviolet regions of the electromagnetic spectrum and converts the absorbed light into heat. The light absorber is typically highly absorptive of the selected imaging light, providing a light-to-heat conversion layer or transfer layer with an absorbance at the wavelength of the imaging light in the range of about 0.1 to about 3 or higher (approximately absorption of 20 to 99.9% or more of incident light at a specific wavelength). Typically the absorbance of the light-to-heat conversion layer or transfer layer at the wavelength of the imaging light is around 0.1, 0.2, 0.3, 0.4, 0.6, 0.8, 1.0, 1.25, 1.5, 2, 2.5, or or somewhere in between, or larger.

“Absorbance” is the absolute value of the logarithm (base 10) of the ratio of a) the intensity of light transmitted through the layer (typically in the shortest direction) and b) the intensity of light incident on the layer. For example, an absorbance of 1 corresponds to transmission of approximately 10% of incident light intensity; an absorbance of greater than 0.4 corresponds to transmission of less than approximately 39.8% of incident light intensity.

In one embodiment, although the light-to-heat conversion layer or transfer layer is highly absorptive of light in the wavelength region or specific wavelength used for imaging, the light-to-heat conversion layer or transfer layer is much less absorptive (e.g. transparent, semitransparent, or translucent) in another wavelength region or specific wavelength. For example, an light-to-heat conversion layer or transfer layer imaged with a laser having maximum output around 830 nm can have an absorbance maximum in the wavelength region from 750 to 950 nm, while simultaneously having a absorbance maximum in the region from 400 to 750 nm that is at least 5 times smaller (e.g., the highest absorbance from 750 to 900 nm is at 840 nm, and absorbance (840 nm) is 0.5, while the highest absorbance from 400 to 750 is at 650 nm, and absorbance (650 nm) is 0.09).

In one embodiment, this regional ratio of absorbance of the imaging region to the non-imaging region typically will be greater than 1 so that the non-imaging region is relatively transparent; for example a ratio greater than a selection from 2, 4, 8, 12, 16, 32, or greater. This ratio of absorbance at given wavelength regions can be applied to the light-to-heat conversion layer or transfer layer, and also to any significant absorber in the light-to-heat conversion layer or transfer layer (for example, any specific absorber such as one accounting for at least 10% of the absorption of the imaging light can be characterized by the ratio, e.g., 2-(2-(2-chloro-3-(2-(1,3-dihydro-1,1-dimethyl-3-(4-sulfobutyl)-2H-benz[e]indol-2-ylidene)ethylidene)-1-cyclohexene-1-yl)ethenyl)-1,1-dimethyl-3-(4-sulfobutyl)-1H-benz[e]indolium, inner salt, (1,3-dihydro-1,1-dimethyl-3-(4-sulfobutyl)-2H-benz[e]indol-2-ylidene)ethylidene)-1-cyclohexene-1-yl)ethenyl)-1,1-dimethyl-3-(4-sulfobutyl)-1H-benz[e]indolium, inner salt, free acid having CAS No. [162411-28-1]).

In one embodiment, the light-to-heat conversion layer or transfer layer is notably absorptive of light at certain imaging wavelengths, but is notably transmissive of light at some other wavelength. For example in one prophetic embodiment, while absorbing 90% of light at 832 nm in wavelength (absorbance 1 at a wavelength used for imaging by an infrared laser), only 20.6% of light at 440 nm in wavelength would be absorbed (absorbance 0.10, at a blue wavelength), allowing the donor to transmit far more light at a visible wavelength than at an imaging wavelength of the infrared. The ratio of absorbance (imaging wavelength to other wavelength) in that case is 10.

Transmission at the other wavelength need not be complete, but should be improved; an absorbance ratio varying from as low as 3 to as high as 100, or higher, can be useful. For example in visual inspections, a ratio favoring a visible wavelength for the selectively transmitted wavelength, selected from ratios of 5, 10, 15, 30, and 60 or higher should be useful. Useful wavelengths for transmission of light through an light-to-heat conversion layer or transfer layer include 300 and 350 nm in the ultraviolet spectrum, 400, 450, 500, 550, 600, 650, 670, 700, and 750 nm in the visible spectrum, and 770, 800, 850, 900, 1000, and 1200 nm in the infrared spectrum. Useful wavelengths for absorbance to generate heat include wavelengths such as 671, 780, 785, 815, 830, 840, 850, 900, 946, 1047, 1053, 1064, 1313, 1319, and 1340 nm, corresponding to laser output wavelengths. A layer transmitting 20% or more of light at a given wavelength can be said to be (relatively) transparent at that wavelength. Transparency improves as transmission improves, e.g., from 20 to 30 to 40 to 50 to 60 to 70 to 80 to 90 to 95% or higher transmission at a given wavelength, transparency improves in a light-to-heat conversion layer or transfer layer. Scattering of light should also be minimized to improve transparency by minimizing backscatter and scattering losses.

The use of a highly absorptive material for the imaging radiation allows a very thin light-to-heat conversion layer to be constructed. A thin light-to-heat conversion layer can be useful in producing high localized temperatures by light absorption. In one embodiment, the thickness of the light-to-heat conversion layer is equal to or less than about 500 nm. Other useful thicknesses include less than or equal to about 400 nm, about 300 nm, about 200 nm, about 150 nm, about 100 nm, about 75 nm, about 50 nm, and about 30 nm.

Although thinner light-to-heat conversion layers are preferred, thicker layers can also be used, commonly up to about 5 μm in thickness. For example, in one embodiment, the thickness of a typical light-to-heat conversion layer ranges from 50 nm to 250 μm. Thickness is easily optimized by experiment. Sometimes, very thin films may not achieve a suitably high and constant amount of light absorption. In order to achieve a manageable amount of thermal energy and temperature during the imaging process, the thickness is typically varied according to the concentration and effectiveness of the light absorbers present. This allows for a necessary transfer of material from the transfer layer on to the receiving layer, without deleterious side effects.

It is often useful to select a light absorber that can absorb a significant amount of light with only a thin light-to-heat conversion layer. For example, if an light-to-heat conversion layer of 0.2 μm thickness has an absorbance of 0.2 for light at a wavelength of 830 nm, the layer can be said to have an absorbance coefficient of 1/μm, at 830 nm. In one embodiment, the light-to-heat conversion layer has at least one absorbance coefficient between two choices from 0.01, 0.1, 0.5, 1.0, 2.0, 4, 8, 16, 32, 64, and 125/μm at a wavelength between 750 and 1400 nm. In one embodiment, the light absorber in the light-to-heat conversion layer contributes more than 0.1 units of the absorbance for at least one wavelength in at least one of the visible, short wavelength mid-infrared, and long wavelength mid-infrared wavelength bands of light.

Suitable light absorbing materials for the light-to-heat conversion layer can include, for example, dyes (e.g., visible dyes, ultraviolet dyes, infrared dyes including near infrared dyes, fluorescent dyes, and radiation-polarizing dyes), pigments, metals, metal compounds, metal films, and other suitable absorbing materials.

Dyes suitable for use as light absorbers in a light-to-heat conversion layer may be present at least in part (>5%) in dissolved form, or in at least partially dispersed form, rather than practically entirely (>80%) in a particulate form as for pigments. In one embodiment, the light absorber most responsible for the absorbance at the imaging wavelengths is a dye completely or partially (>5%) dissolved in the light-to-heat conversion layer. In one embodiment, the light absorber most responsible for the absorbance at the imaging wavelengths is practically dissolved (>80%) in a formulation when applied to the donor element construction, and becomes partially dispersed later.

Examples of dyes and pigments suitable as light absorbers in a light-to-heat conversion layer include polysubstituted phthalocyanine compounds and metal-containing phthalocyanine compounds; metal-complex compounds, benzoxazole compounds, benz[e,f, or g]indolium compounds, indocyanine compounds, cyanine compounds; squarylium compounds; chalcogenopyryloacrylidene compounds; croconium and croconate compounds; metal thiolate compounds; bis(chalcogenopyrylo) polymethine compounds; oxyindolizine compounds; indolizine compounds; pyrylium and metal dithiolene compounds, bis(aminoaryl) polymethine compounds; merocyanine compounds; thiazine compounds; azulenium compounds; xanthene compounds; and quinoid compounds. Light absorbing materials disclosed in the following references are also suitable herein when used with an appropriate light source and are incorporated by reference:

(1) U.S. Pat. No. 5,108,873, “IR-ray absorptive compound and optical recording medium by use thereof”;

(2) U.S. Pat. No. 5,036,040, “Infrared absorbing nickel-dithiolene dye complexes for dye-donor element used in laser-induced thermal dye transfer”;

(3) U.S. Pat. No. 5,035,977, “Infrared absorbing oxonol dyes for dye-donor element used in laser-induced thermal dye transfer”;

(4) U.S. Pat. No. 5,034,303, “Infrared absorbing trinuclear cyanine dyes for dye-donor element used in laser-induced thermal dye transfer”;

(5) U.S. Pat. No. 5,024,923, “Infrared absorbent compositions”;

(6) U.S. Pat. No. 5,019,549, “Donor element for thermal imaging containing infra-red absorbing squarylium compound”;

(7) U.S. Pat. No. 5,019,480, “Infrared absorbing indene-bridged-polymethine dyes for dye-donor element used in laser-induced thermal dye transfer”;

(8) U.S. Pat. No. 4,973,572, “Infrared absorbing cyanine dyes for dye-donor element used in laser-induced thermal dye transfer”;

(9) U.S. Pat. No. 4,952,552, “Infrared absorbing quinoid dyes for dye-donor element used in laser-induced thermal dye transfer”;

(10) U.S. Pat. No. 4,950,640, “Infrared absorbing merocyanine dyes for dye-donor element used in laser-induced thermal dye transfer”;

(11) U.S. Pat. No. 4,950,639, “Infrared absorbing bis(aminoaryl)polymethine dyes for dye-donor element used in laser-induced thermal dye transfer”;

(12) U.S. Pat. No. 4,948,778, “Infrared absorbing oxyindolizine dyes for dye-donor element used in laser-induced thermal dye transfer”;

(13) U.S. Pat. No. 4,948,777, “Infrared absorbing bis(chalcogenopyrylo)polymethine dyes for dye-donor element used in laser-induced thermal dye transfer”;

(14) U.S. Pat. No. 4,948,776, “Infrared absorbing chalcogenopyrylo-arylidene dyes for dye-donor element used in laser-induced thermal dye transfer”;

(15) U.S. Pat. No. 4,942,141, “Infrared absorbing squarylium dyes for dye-donor element used in laser-induced thermal dye transfer”;

(16) U.S. Pat. No. 4,923,638, “Near infrared absorbing composition”;

(17) U.S. Pat. No. 4,921,317, “Infrared absorbent comprising a metal complex compound containing two thiolato bidentate ligands”;

(18) U.S. Pat. No. 4,913,846, “Infrared absorbing composition”;

(19) U.S. Pat. No. 4,912,083, “Infrared absorbing ferrous complexes for dye-donor element used in laser-induced thermal dye transfer”;

(20) U.S. Pat. No. 4,892,584, “Water soluble infrared absorbing dyes and ink-jet inks containing them”;

(21) U.S. Pat. No. 4,791,023, “Infrared absorbent and optical material using the same”;

(22) U.S. Pat. No. 4,788,128, “Transfer Printing Medium with Thermal Transfer Dye and Infra-Red Radiation Phthalocyanine Absorber”;

(23) U.S. Pat. No. 4,767,571, “Infrared absorbent”;

(24) U.S. Pat. No. 4,675,357, “Near infrared absorbing polymerizate”;

(25) U.S. Pat. No. 4,508,811, “Recording element having a pyrylium or thiopyrylium-squarylium dye layer and new pyrylium or thiopyrylium-squarylium compounds”;

(26) U.S. Pat. No. 4,446,223, “Recording and information record elements comprising oxoindolizine and oxoindolizinium dyes”;

(27) U.S. Pat. No. 4,315,983, “2,6-Di-tert-butyl-4-substituted thiopyrylium salt, process for production of same, and a photoconductive composition containing same”; and

(28) U.S. Pat. No. 3,495,987, “Photopolymerizable Products”.

A source of suitable infrared-absorbing dyes (including near-, mid-, and far-infrared absorbing dyes) is H. W. Sands Corporation, Jupiter, Fla. Suitable dyes include 2-(2-(2-chloro-3-(2-(1,3-dihydro-1,1-dimethyl-3-(4-sulfobutyl)-2H-benz[e]indol-2-ylidene)ethylidene)-1-cyclohexene-1-yl)ethenyl)-1,1-dimethyl-3-(4-sulfobutyl)-1H-benz[e]indolium, inner salt, free acid having CAS No. [162411-28-1], available from H. W. Sands Corp., as SDA-4927; 2-[2-[2-(2-pyrimidinothio)-3-[2-(1,3-dihydro-1,1-dimethyl-3-(4-sulfobutyl)-2H-benz[e]indol-2-ylidene)]ethylidene-1-cyclopenten-1-yl]ethenyl]-1,1-dimethyl-3-(4-sulfobutyl)-1H-benz[e]indolium, inner salt, sodium salt, having molecular formula C41H47N4Na1O6S3 and molecular weight of about 811 g/mole, available from H. W. Sands Corp., as SDA-5802; indocyanine green, having CAS No. [3599-32-4] C43H47N2Na1O6S2, and molecular weight of about 775 g/mole, available from H. W. Sands Corp., as SDA-8662; 3H-indolium, 2-[2-[2-chloro-3-[(1,3-dihydro-1,3,3-trimethyl-2H-indol-2-ylidene)ethylidene]-1-cyclopenten-1-yl]ethenyl]-1,3,3-trimethyl-, salt with trifluoromethanesulfonic acid (1:1) having CAS No. [128433-68-1] and molecular weight of about 619 g/mole, available from Hampford Research, Inc, Stratford, Conn.; or Pisgah Laboratories, Pisgah Forest, N.C. as TIC-5C. Examples of other such dyes may be found in Matsuoka, M., Infrared Absorbing Materials, Plenum Press, New York, 1990, and in Matsuoka, M., Absorption Spectra of Dyes for Diode Lasers, Bunshin Publishing Co., Tokyo, 1990. IR absorbers marketed by American Cyanamid Co., Wayne, N.J.; Cytec Industries, West Paterson, N.J. or by Glendale Protective Technologies, Inc., Lakeland, Fla., under the designation CYASORB IR-99 (CAS No. [67255-33-8]), IR-126 (CAS No. [85496-34-0]) and IR-165 (N,N′-2,5-cyclohexadiene-1,4-diylidenebis[4-(dibutylamino)-N-[4-(dibutylamino)phenyl]benzenaminium bis[(OC-6-11)-hexafluoroantimonate(1-)], CAS No. [5496-71-9]) may be used.

A specific dye may be chosen based on factors such as solubility in, and compatibility with, a specific binder and/or coating solvent of the light-to-heat conversion layer, as well as the wavelength ranges of absorption necessary, desired, undesired, and forbidden for the light-to-heat conversion layer.

Pigmentary materials may also be used in the light-to-heat conversion layer as light absorbers. Examples of suitable pigments include carbon black and graphite, as well as phthalocyanines, nickel dithiolenes, and other pigments. Additionally, black azo pigments based on copper or chromium complexes of, for example, pyrazolone yellow, dianisidine red, and nickel azo yellow are useful. Inorganic pigments are also valuable. Examples include oxides and sulfides of metals such as aluminum, bismuth, tin, indium, zinc, titanium, chromium, molybdenum, tungsten, cobalt, iridium, nickel, palladium, platinum, copper, silver, gold, zirconium, iron, lead or tellurium. Metal borides, carbides, nitrides, carbonitrides, bronze-structured oxides, and oxides structurally related to the bronze family are also of utility.

Another suitable light-to-heat conversion layer includes metal or metal/metal oxide formed as a thin film, for example, black aluminum (i.e., a partially oxidized aluminum having a black visual appearance) or chrome. Metallic and metal compound films may be formed by techniques such as, for example, sputtering and evaporative deposition. Particulate coatings may be formed using a binder and any suitable dry or wet coating techniques.

In one embodiment, the donor element has a layer having at least one particulate light absorber such as carbon black.

In one embodiment, the donor element includes a layer having at least one non-particulate light absorber such as a dye. A benefit of a dissolved light absorber is that homogeneous layers without particle agglomeration can be formed, so that very thin layers absorb light homogeneously. Another benefit of a dissolved light absorber is that light scattering is less. It is possible for a dissolved light absorber to be accompanied by an undissolved form of the same light absorber. In one embodiment, the dissolved (non-particulate) form of a light absorber constitutes the majority by mass of that absorber.

In one embodiment, the donor element includes a layer having at least one spectrum-selective non-particulate light absorber such as an infrared dye. A benefit of a spectrum-selective light absorber is that the absorbance spectrum can be selected for utility with the imaging light source, and the transmission spectrum can be selected for utility with a focusing laser or with inspection procedures by human or machine.

In one embodiment, a light absorber as described for the light-to-heat conversion layer is incorporated into the transfer layer of a donor element for the purpose of causing or assisting the transfer of material to the receiver element during imaging. A separate light-to-heat conversion layer may be present or absent in such an embodiment (as is true, in fact, for any embodiment).

The receiver element is the object that accepts the transfer of material from the transfer layer according to the pattern of imaging. The receiver element may consist of any object, typically a sheet-like object, for example a single layer, or a multi-layer element. There is no particular limitation on the materials suitable for employment in the receiver except that the receiver is capable of retaining the transferred image and that it be reasonably dimensionally stable. The receiver element can comprise a dimensionally stable sheet material or a rigid object. The assemblage can be imaged through the receiver element if that element is sufficiently transparent. Examples of transparent films for receiver elements include, for example polyethylene terephthalate, polyether sulfone, a polyimide, a poly(vinyl alcohol-co-acetal), polyethylene, or a cellulose ester, such as cellulose acetate. Examples of opaque receiver element materials include, for example, polyethylene terephthalate filled with a white pigment such as titanium dioxide, ivory paper, or synthetic paper, such as Tyvek® spunbonded polyolefin. Paper supports are typical and are preferred for proofing applications, while a polyester support, such as polyethylene terephthalate is typical and is preferred for a medical hardcopy and color filter array applications. Roughened supports may also be used in the receiver element A rigid object such as a sheet of glass or a glass color filter substrate can also be the receiver element. The receiver element can comprise one or more instances of layers such as a receiving layer, a deformable layer, a release layer, and a receiver support layer. Other useful receiver element components are also disclosed in U.S. Pat. No. 5,534,387 issued on Jul. 9, 1996.

The donor element and receiver element are brought into contact or intermittent contact and held together by a force in an assemblage. The alignment of donor element is that the transfer layer is between the receiver element and the support layer of the donor layer.

Vacuum and/or pressure can be used to hold the donor element (10) and the receiver element (40) together to form the assemblage. A vacuum table provides a convenient method to form an assemblage and position it for imaging. In one embodiment, the receiver element is placed on a vacuum table and a wider and longer donor element is positioned to completely cover the receiver element and overlap onto the vacuum table. The vacuum table draws air from between the donor element and the receiver element until the atmospheric pressure between the two elements is low and they are drawn together. A roller can be used to push trapped air bubbles away to the outer edges of the receiver element where the air bubbles are drawn away by the vacuum. Typically this evacuation brings the transfer layer outer surface and the outer surface of the receiving element into contact, unless for example a mask or target intervenes. If each surface of the elements is smooth, the contact can be intimate and continuous over a large area. If either surface is not smooth enough, the contact can be intermittent. For example, a roughened surface on either element can be present to avoid large trapped air bubbles, and the roughening can prevent continuous contact. A previously imaged receiver element having protruding areas of transfer layer from a previous imaging can prevent the donor element from conforming completely to the topography of the receiver element. An inherently non-planar receiver element such as a color filter array of a glass substrate bearing a black mask defining pixel elements can also prevent the donor element from conforming completely to the topography of the receiver element.

As one alternative, the assemblage can held together by fusion at the periphery. As another alternative, the assemblage can be held together by taping the donor and receiver element together and the assemblage is then taped to the imaging apparatus, or a pin/clamping system can be used. As yet another alternative, the donor can be laminated to the receiver element to form an assemblage. The assemblage can be conveniently mounted on a drum to facilitate laser imaging. Those skilled in the art will recognize that a variety of architectures such as flatbed, internal drum, capstan drive, etc. can also be used with this invention.

There are many possible sources of thermal energy capable of causing a transfer of an image; for example a thermal print head or a beam of radiation, where the radiation could include at least one of ultraviolet, visible, or infrared light. A lamp or a laser can supply the beam of radiation. This invention contemplates imaging of three or more features simultaneously. For an imaging head capable of imaging multiple features simultaneously, lasers are particularly preferred, and therefore will be used for descriptive and illustrative purposes. In one embodiment, a multiplicity of infrared-emitting diode lasers provides a multiple-beam imaging head that can be scanned across an assemblage. In one embodiment the imaging head has about 200 abutted beams emitting at around 832 nm, each beam capable of illuminating a rectangular region 20 microns wide perpendicular to the scan direction, thereby capable of spanning 4 mm of assemblage while writing a number of features simultaneously when moved over the assemblage. Typically there is a known relationship between the area illuminated and the area transferred, which is nearly one to one. The width transferred by a contiguous set of illuminated beams bordered by an unilluminated area defines a local width. Scans of the multiple-beam imaging head can occur at any convenient speeds, such as at or between 0.1, 1, 2, 5, and 10 meters per second. The speed of scanning defines the local length of an area or feature. The beams of light can be modulated by any conventional technique, such as a linear light valve. Gelbart describes a suitable apparatus in U.S. Pat. No. 5,517,359.

In any imaging method useful for this invention, the thermal energy deposited during imaging also causes a separation of support layer from its position relative to the receiver element in the area and vicinity of the imaging, rather like a blister forming between the support layer and the receiver element. The separation has a maximum value, termed the excess assemblage separation, that is analogous to the height of a blister. This separation can be temporary; it can disappear for example upon cooling from the heat generated in the assemblage by imaging, or by dissipation of the force causing separation. The maximum separation distance of the receiver element and the support layer can be about or between any distance(s) chosen from 0.05, 0.1, 0.2, 0.5, 1.0, 2.0, 4.0 or more microns. Although this added distance of separation of the support layer and the receiver element is small, the area of some separation (analogous to the area of a blister, the area generally perpendicular to the distance of separation) can be substantially larger. For example, the largest dimension of the area of separation outside the area of imaging that is separated due to imaging has been found to be about 150 microns for a pattern of lines and spaces of 100 micron imaged lines with a donor element comprising 1-2 micron colored transfer layer and a 50 micron polyethylene terephthalate support layer.

Since imaging causes an area of separation around each feature imaged, when features are close areas of separation can partially overlap and join. This joining provides an interaction between features at the time of imaging, and has been found to subtly change the amount of transfer layer that arrives at the receiver element. Typically, more transfer layer arrives at the receiver element when there is no interaction; somewhat less transfer layer arrives at the receiver element when an imaged feature is close enough to another neighboring imaged feature that their areas of separation overlap and join, and even less transfer layer arrives at the receiver element of an imaged feature that is close enough to two other neighboring imaged features that each neighboring feature's area of separation joins with the area of separation of the feature.

Imaging can be bilevel or continuous tone (contone). In one embodiment, the utility of the present invention extends to bilevel imaging. In bilevel imaging, the percentage of transfer layer deposited on the receiver element in the imaged areas is relatively close to 100%, and nearly constant, over a range of successful imaging powers; the percentage is basically not continuously variable from 0 to 100% by changes in the imaging power as in continuous tone imaging. Bilevel imaging is well suited to line art, halftone imaging, and manufacturing such as color filter production. Mechanisms of assemblage imaging known for utility in bilevel imaging include mass transfer, melt transfer, ablative transfer, and laser induced film transfer.

In a mass transfer system, all or the majority of the material of the transfer layer on the donor element (e.g., binder, functional material such as colorant, and additives) is transferred to the receiver element. This can occur for example by a melt mechanism or by an ablation mechanism. In a melt mechanism, the donor material is softened or melted. This softened or molten material then flows across to the receiver or adheres to it. This is typically the mechanism at work in a thermally induced wax transfer system. In an ablation mechanism, gases are generated that explosively propel the donor material across to the receiver. This results from at least partially volatilizing the binder or other additives in and/or under a layer of the donor material to generate propulsive forces to propel the transfer layer toward the receiver element.

The image formed from a mass transfer system can ideally be termed a bilevel or halftone image. In a system that forms halftone images, the transfer gives a bi-level image in which either zero or a predetermined density level is transferred in the form of discrete areas (i.e., features) or dots. In one embodiment, dots can be randomly or regularly spaced per unit area, but are normally too small to be resolved by the naked eye. Thus, the perceived optical density in such a half tone image can be controlled by the size and the number of discrete dots per unit area. The smaller the fraction of a unit area covered by the dots, the less dense the image will appear to an observer.

The image on a color proof formed from a dye transfer system is typically a continuous tone (i.e., contone) image. In a continuous tone or contone image, the perceived optical density is a function of the quantity of colorant per pixel, higher densities being obtained by transferring greater amounts of colorant. To emulate half tone images using a thermal dye transfer system, a laser beam can be modulated by electronic signals that are representative of the shape and color of the original image to heat and ultimately volatilize dye only in those areas where the dye is required on the receiver element to reconstruct the color of the original object. Further details of this process are disclosed in GB Publication No. 2,083,726 (3M). U.S. Pat. No. 4,876,235 (DeBoer) and U.S. Pat. No. 5,017,547 (De Boer) also disclose a thermal dye transfer system in which the perceived optical density is obtained by controlling the tonal gradation or thickness (density) of the colorant per pixel. In this system, the receiver element also includes spacer beads to prevent contact between the donor element and receiver element. This allows for the dye to diffuse or sublime across to the receiver element without the binder.

The shape and/or definition of the dots can affect the quality of the image. For example, dots with more well-defined and sharper edges will provide images with more reproducible and accurate colors. The shape and/or definition of the dots are typically controlled by the mechanism of transfer of the image from the donor element to the receiver element. For example, as a result of the propulsive forces in an ablation system, there is a tendency for the colorant to “scatter” and produce less well-defined dots made of many fragments. Attempts have been made to produce better-defined dots using an ablation system, such as those described in U.S. Pat. No. 5,156,938 (Foley) and U.S. Pat. No. 5,171,650 (Ellis).

The ability to image using a laser-imaging source introduces significant advantages. For imaging by means of laser-induced transfer, the donor element typically includes a support bearing, in one or more coated layers, an absorber for the laser radiation, a transferable colorant, and one or more binder materials. When the donor element is placed in contact with a suitable receiver element and subjected to a pattern of laser irradiation, absorption of the laser radiation causes rapid build-up of heat within the donor element, sufficient to cause transfer of colorant to the receiver element in irradiated areas. By repeating the transfer process using different donor elements and the same receiver element, it is possible to superimpose several monochrome images on a common receiver element, thereby generating a full color image. This process is ideally suited to the output of digitally stored image information. It has the additional benefits of not requiring chemical processing and of not employing materials that are sensitive to normal white light.

As discussed above, laser-induced transfer can involve either mass transfer of the binder, colorant and infrared absorber, giving a bi-level image in which either zero or maximum density is transferred (depending on whether the applied energy exceeds a given threshold), or dye sublimation transfer, giving a continuous tone image (in which the density of the transferred image varies over a significant range with the energy absorbed). Laser-induced mass transfer has been characterized in the literature, in Applied Optics, 9, 2260-2265 (1970), for example, as occurring via two different modes. One mode involves a less energetic mode in which transfer occurs in a fluid state (i.e., by melt transfer), and one mode involves a more energetic mode in which transfer occurs by an explosive force, as a result of generation and rapid expansion of gases at the substrate-coating interface (i.e., by ablation transfer). This distinction has also been recognized in U.S. Pat. No. 5,156,938 (Foley), U.S. Pat. No. 5,171,650 (Ellis), U.S. Pat. No. 5,516,622 (Savini), and U.S. Pat. No. 5,518,861 (Covalaskie), which refer to ablation transfer as a process distinct from melt transfer, and refer to its explosive nature, as opposed to U.S. Pat. No. 5,501,937 (Matsumoto), U.S. Pat. No. 5,401,606 (Reardon), U.S. Pat. No. 5,019,549 (Kellogg), and U.S. Pat. No. 5,580,693 (Nakajima), which refer to transfer of a colorant in a molten or semi-molten (softened) state, with no mention of explosive mechanisms.

Thermal transfer systems have been developed that overcome the disadvantages previously described for the dye transfer systems and mass transfer systems. These systems utilize a mechanism referred to as laser-induced film transfer (LIFT) and multi-LIFT, which is utilized when there is more than one layer of transfer material. Such systems have been reported in U.S. Pat. No. 5,935,758 (Patel et al.) and U.S. patent application Ser. No. 10/461,738 (Kidnie et al.). The LIFT system includes components such as crosslinking agents and bleaching agents to further promote a more controllable dot size and more reproducible and accurate colors. The crosslinking agent reacts with the donor binder upon exposure to infrared laser radiation to form a high molecular weight network. The net effect of this crosslinking is better control of the melt flow phenomena, transfer of more cohesive material to the receiver element and higher quality dots. Although other systems involve crosslinking a colorant layer subsequent to transfer to the receiver element to prevent back transfer during transfer of the next colorant layer, as in U.S. Pat. No. 5,395,729 (Reardon) and EP 160 395 (ICI) and 160 396 (ICI), the ability to effect crosslinking as a direct result of laser transfer, and hence produce a durable transferred image that is not prone to back transfer represents an improvement over Reardon and ICI.

Using the LIFT or multi-LIFT systems, a half tone image can be formed by the transfer of discrete dots of a film of binder, colorant and additives from the donor element to a receiver element. The dots are formed from a molten or softened film and have well-defined, generally continuous edges that are relatively sharp with respect to density or edge definition; in other words, the dots are formed with relatively uniform thickness over their area. This is in contrast to the dye transfer and mass transfer methods previously described. Dye transfer methods involve transfer of the colorant without the binder and mass transfer methods such as ablation propel fractions of the transfer material but at least partially decomposing the binder. Neither of these methods produces well defined dots with relatively uniform thickness.

### Examples 1 and 2

For Example 1, a donor element was made with a blue thermal mass transfer layer of approximately 1.5 microns dry thickness on a support layer of 100 microns of polyester terephthalate having a Young's modulus of over 1.7 gPa. For Example 2, a donor element was made with a blue thermal mass transfer layer of 1.5 microns dry thickness on a support layer of 25 microns of polyester terephthalate having a Young's modulus of over 1.7 gPa.

The imaging head uses 200 beams of diode laser light at 832 nm wavelength, each beam abutted in a line to its neighbor(s) and illuminating an area 20 microns wide. The head was moved linearly at about 1 meter per second to illuminate bands of 5 beams (100 microns) in width separated by unilluminated beams. The power (about 17 watts) and travel speed of the head were adjusted to produce good images of lines and spaces.

The assemblages were made on a flat vacuum table and consisted of a piece of glass serving as a receiver element, covered by a larger piece of donor element, with the area in between evacuated by application of vacuum to the vacuum table.

The line features imaged onto the receiver element were stripes of blue donor material, each 100 microns wide and at least ten centimeters long, separated by unimaged spaces of a constant width for each stroke of the imaging head due to unilluminated beams (the spaces thereby being multiples of 20 microns).

After separation of the imaged receiver element from the spent donor by peeling, the imaged receiver element was annealed by heating in air at approximately 200 C. for 1 hour. After cooling, the annealed receiver was scanned and image analysis was performed for average color values of each imaged line in units of RGB (where R=0, G=0, B=0 is black, R=0, G=0, B=255 is blue, and R=255, G=255, B=255 is white).

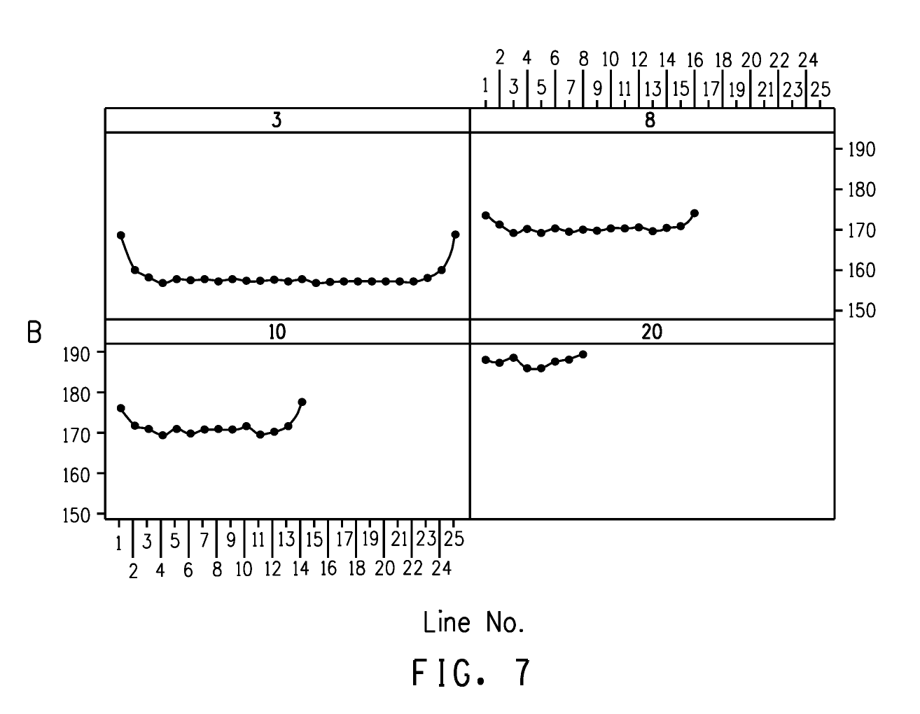

FIG. 7 shows the results for a support layer 100 microns thick for the blue index of RGB. Four sets of results are shown, from the upper left, designated “3”, “8”, “10”, and “20”. Each designation corresponds to the number of beam positions turned off between the illuminated line features in the 200 beam head. For 3 beams turned off, the 100 micron lines are separated by spaces of 60 microns; for 20 beams turned off, the lines are separated by spaces of 400 microns. For a (line plus space) of 5+3=8 beams in the chart designated “3”, the 200 beam head supplies 25 lines per imaging pass. For a (line plus space) of 5+20=25 beams in the chart designated “20”, the 200 beam head supplies 8 lines per imaging pass. The lines imaged are numbered from feature 1 to feature 25, and that index value is used on the abscissa. The ordinate value for each chart is B, where R, G, and B are the color values of the transferred features in the RGB color space of the International Commission on Illumination (abbreviated as CIE from its French title Commission Internationale de l'Eclairage), as measured by a spectrophotometer such as is available from Ocean Optics, Dunedin, Fla. A black feature (no light reaches the eye) would have R, G, and B equal to 0; a white feature (all light reaches the eye) would have R, G, and B equal to 255. Darker blue is farther from B=255, in other words a more successful transfer of more mass with more pigment takes out more light and decreases the B value. So a value of B=165 is expected to be a thicker amount of transferred colorant than a value of B=170.

It is notable in the top left chart of FIG. 7 that the outermost features 1 and 25 have the largest ordinate values, in other words the least colored transfer layer has been transferred. These outermost features have 1 closely neighboring feature; the other 23 inner features show more pigment color due to the presence of more transfer layer. Since the 23 inner features and two outer features were imaged during a single stroke of the imaging head, we would expect that the inner features might interact more so than the outer features, and thus may have experienced a more separated assemblage than the two outermost features.

The top right chart of FIG. 7 shows the result when the distance between features is increased to 8 beam widths, approximately 160 microns. With this combination of lines and spaces, 16 features were imaged onto the glass and measured for color. It is notable that the two outermost features still show a larger B value than the 14 inner features. The difference is not as great as for the 3 beam separation. Although there is still interaction between features, and more so for inner features than outer features, the effect does wane with greater separation.

The bottom right chart of FIG. 7 shows the result when the distance between features is increased to 20 beam widths, approximately 400 microns. The variation in the B value between inner and outer features is now comparable to the variation between any two features. At separations of 400 microns, within the sensitivity of this determination, features of 100 micron width made 8 at a time with a laser imaging head from a donor element having a polyethylene terephthalate support of 100 microns thickness show a comparable color characteristic, unaffected by positioning of neighbors on the laser head.

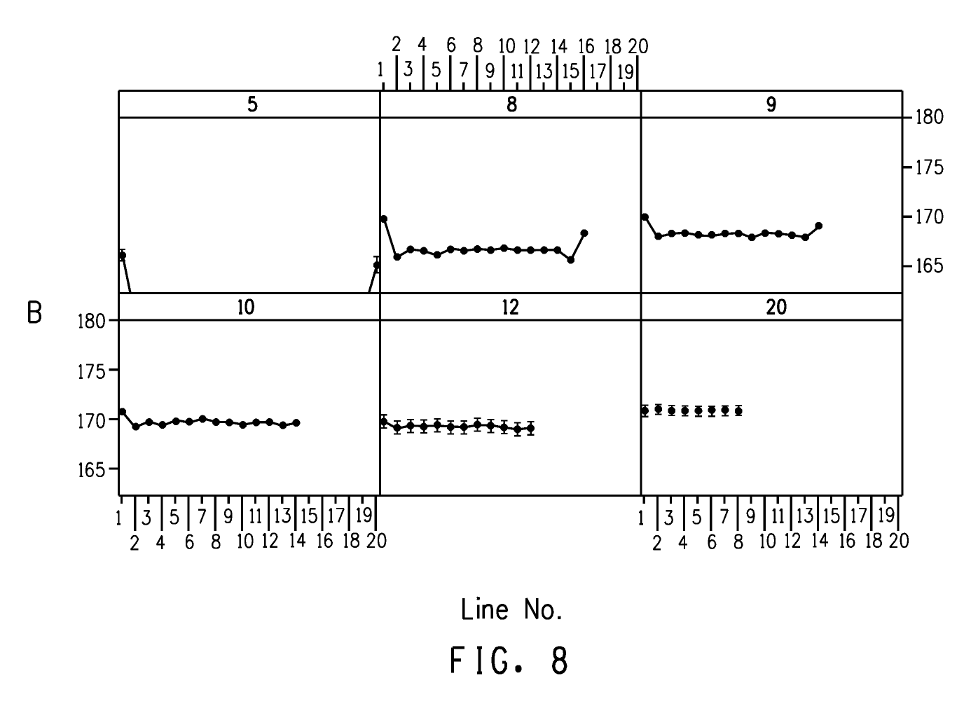

FIG. 8 shows analogous data for the case of the support layer being 25 microns in thickness rather than 100 microns. A similar trend is obvious: the more closely spaced line features such as those at 160 micron separation in the chart labeled “8” show a large difference in the color of the two outermost features (1 and 16) in comparison to the rest of the inner features (2 to 15), but at large separations of the line features such as those of 400 micron separation in the chart labeled “20”, the difference between the outermost lines (1 and 8) and the inner lines (2 to 7) is hard to discern.

It is also true that for a separation of lines by fixed spaces, that a thinner support layer leads to inner and outer lines being more similar. For the imaging by the 200 beam head of 100 micron lines separated by 200 micron spaces, images were compared by subtracting the average B value of the two outermost line features with the average B value of the twelve inner line features. For the 100 micron support layer, the difference found in eight separate images was 8.6 units with a standard deviation of 0.4 units; while for the 25 micron support layer, the difference was 1.4 units with a standard deviation of 0.3 units. The flexibility of the thinner base gave the unexpected result of desirable, more similar, images being made by a multiple beam head.

Vocabulary

donor element 10

support layer 20

transfer layer 30

adjacent

contact

receiver element 40

assemblage 50

means of aligning

vacuum table 60

force

mass

radiation

light

multiple-beam imaging head 70

moving in a direction 90 relative to the assemblage

beams of imaging radiation 85

radiation sources 80

illuminated pattern 95

thick support layer 120 of relatively low flexibility

multiple radiation sources (3 or more)

not drawn to scale

### DEFINITIONS

### Young's Modulus, E, the Ratio of Tensile Stress to Tensile Strain Below the Proportional Limit

$$E = \frac{P / A}{Δ L / {L}_{0}} = \frac{σ}{ɛ} .$$

Related to shear modulus, G, and bulk modulus, B, as follows

E=2G(1+v)=3B(I−2v)

where

v=Poisson's Ratio

The ratio of normal stress to corresponding strain for tensile or compressive stresses below the proportional limit of the material which is the greatest stress a material is capable of sustaining without any deviation from proportionality of stress to strain (see HOOKE'S LAW). For perfectly elastic materials, it is the ratio of the change in stress to change in strain within the elastic limits. See also MODULUS OF ELASTICITY.

Modulus of Elasticity

Definition: The ratio of stress (nominal) to corresponding strain below the proportional limit of a material. It is expressed in force per unit area, usually pounds per square inch or kilograms-force per square centimeter. The strain may be a change in length. Young's modulus; a twist or shear, modulus of rigidity or modulus of torsion; or a change in volume, bulk modulus. In the SI, all types of moduli of elasticity are reported in pascals, the conversion factor being one psi=6.894 757 E+3 pascals. Also known as ELASTIC MODULUS and YOUNG'S MODULUS.

Flexural modulus: The ratio, within the elastic limit, of the applied stress on a test specimen in flexure, to the corresponding strain in the outermost fibers of the specimen.

General Description

Polyethylene is a widely used, inexpensive, thermoplastic. It has good inherent lubricity, and is easy to process. Polyethylene has good to excellent chemical resistance. It is also soft and cannot be used in temperatures much above 150 F.

High density polyethylene is the hardest and stiffest version of this material. It does not have the impact strength of low density, but is more resilient. Flexural Modulus 145,000-225,000 psi, 1-1.5 gPa

Low density polyethylene is the softest and most flexible version of this material. It has high elongation giving it excellent Impact Strength.

This is offset by its permanent deformation upon impact.

Flexural Modulus 35,000-48,000 psi 0.24-0.33 gPa
Product Name 2 mil Polyester film for Thermal Color Filters Base support (DTF 6528 or equivalent)
   2 mil Polyester film, superclear polymer-green dye added, with IR Layer pretreatment on one side and anti-stat pretreatment on other side.

| | | | |
|---|---|---|---|
| Modulus, psi | ASTM D-882 | MD | >/=250,000 (176 × 10⁶) |
| (kg/sq · m) | | | |

one psi = 6.894 757E+3 pascals.
1 pascal = 1 newton/sq meter Newton, force for 1 kg-m/sec2

1. A method for thermal mass transfer imaging comprising:
providing a donor element with a support layer having a thickness (h) and a modulus (E), and an adjacent transfer layer;
providing a receiver element;
contacting the receiver element with the transfer layer to form an assemblage;
providing an imaging head having three or more beams of light; and
moving the imaging head relative to the assemblage so the three or more beams each cause imagewise mass transfer of the transfer layer onto the receiver element in a local pattern of three or more areas, each area having a local width (b) and a local separation (2a) distinct from any adjacent local area,
wherein when the modulus is greater than 1.5 and less than or equal to 5 gPa, and the local width (b) is less than or equal to 250 microns and the local separation (2a) is less than or equal to 300 microns, the support layer thickness (h) is less than or equal to 45 microns;
and
wherein when the modulus is greater than 0.05 and less than or equal to 1.5 gPa, and the local width (b) is less than or equal to 250 microns and the local separation (2a) is less than or equal to 500 microns, the support layer thickness (h) is less than or equal to 60 microns.

2. The method of claim 1, wherein the support layer comprises a polyester polymer.

3. The method of claim 1, wherein the support layer comprises a polyethylene terephthalate polymer.

4. The method of claim 1, wherein the support layer comprises a polyethylene polymer.

5. The method of claim 1, wherein the support layer comprises a polyvinyl chloride polymer.

6. The method of claim 1, wherein the support layer thickness (h) is greater than 30 microns and less than 60 microns.

7. The method of claim 1, wherein the support layer thickness (h) is greater than 15 microns and less than or equal to 30 microns.

8. The method of claim 1, wherein the support layer thickness (h) is greater than 3 microns and less than or equal to 15 microns.

9. The method of claim 1, wherein each area has an excess assemblage separation greater than 0.05 microns.

10. The method of claim 1, wherein each area has an excess assemblage separation greater than 0.2 microns.

11. The method of claim 1, wherein the local width (b) is greater than 75 microns and less than or equal to 250 microns.

12. The method of claim 1, wherein the local width (b) is greater than 15 microns and less than or equal to 120 microns.

13. The method of claim 1, wherein the local width (b) is greater than 15 microns and less than or equal to 75 microns.

14. The method of claim 1, wherein the local separation (2a) is greater than 75 microns and less than or equal to 250 microns.

15. The method of claim 1, wherein the modulus is greater than 0.05 and less than or equal to 1.0 gPa.

16. The method of claim 1, wherein the modulus is greater than 0.05 and less than or equal to 0.5 gPa.
